(19) United States
(12) Patent Application Publication
(10) Pub. No.: US 2014/0064810 A1
(43) Pub. Date: Mar. 6, 2014

(54) IMAGE FORMING APPARATUS AND PROCESS CARTRIDGE

(71) Applicants: Takafumi Iwamoto, Shizuoka (JP); Hiroshi Ikuno, Kanagawa (JP); Tetsuya Toshine, Shizuoka (JP); Kazuhiro Egawa, Shizuoka (JP); Toshihiro Ishida, Shizuoka (JP); Yohta Sakon, Kanagawa (JP); Masahiro Ohmori, Kanagawa (JP); Naohiro Toda, Kanagawa (JP)

(72) Inventors: Takafumi Iwamoto, Shizuoka (JP); Hiroshi Ikuno, Kanagawa (JP); Tetsuya Toshine, Shizuoka (JP); Kazuhiro Egawa, Shizuoka (JP); Toshihiro Ishida, Shizuoka (JP); Yohta Sakon, Kanagawa (JP); Masahiro Ohmori, Kanagawa (JP); Naohiro Toda, Kanagawa (JP)

(21) Appl. No.: 13/953,949

(22) Filed: Jul. 30, 2013

(30) Foreign Application Priority Data
Sep. 4, 2012 (JP) 2012-193691

(51) Int. Cl. G03G 21/00; G03G 15/00; G03G 21/18

(52) U.S. Cl. CPC G03G 21/0017
USPC 399/350; 399/111; 399/159

(57) ABSTRACT

An image forming apparatus includes an electrophotographic photoreceptor; and a cleaning blade. The electrophotographic photoreceptor includes an outermost layer having a ten-point average roughness Rz of from 0.5 to 2.4 μm and an average interval between concavities and convexities Sm of from 30 to 300 μm, and the cleaning blade includes a reed-shaped elastic blade having a contact point to the electrophotographic photoreceptor. The contact point includes a substrate; a mixed layer overlying the substrate, including a material forming the substrate and at least one of an acrylic resin and a methacrylic resin and having a thickness not less than 1.0 μm; and a surface layer overlying the mixed layer, including at least one of an acrylic resin and a methacrylic resin and having a thickness not less than 0.1 μm.

### CROSS-REFERENCE TO RELATED APPLICATIONS

This patent application is based on and claims priority pursuant to 35 U.S.C. §119 to Japanese Patent Application No. 2012-193691, filed on Sep. 4, 2012, in the Japan Patent Office, the entire disclosure of which is hereby incorporated by reference herein.

### BACKGROUND

1. Technical Field

The present invention relates to an image forming apparatus such as copiers, printers, facsimiles and direct digital platemakers, and a process cartridge used therein.

2. Description of the Related Art

In electrophotographic image forming apparatuses, residual toner remaining on the surface of a photoreceptor even after a toner image thereon is transferred onto a recording material or an intermediate transfer medium is removed therefrom using a cleaner.

Reed-shaped cleaning blades made of an elastic material such as polyurethane rubbers are typically used for such a cleaner because of having advantages such that the cleaner has simplified structure and good cleanability. Among such cleaning blades, a cleaning blade in which one end thereof is supported by a supporter, and an edge line of the other end is contacted with a surface of a photoreceptor to block and scrape off residual toner on the photoreceptor, thereby removing the residual toner from the surface of the photoreceptor.

In attempting to meet a recent need of forming high quality images, there are image forming apparatuses using spherical toner (hereinafter referred to as polymerization toner), which has a relatively small particle diameter and which is prepared by a method such as polymerization methods. Since such polymerization toner has such an advantage as to have higher transfer efficiency than pulverization toner, which has been conventionally used, the polymerization toner can meet the need. However, polymerization toner has such a drawback as not to be easily removed from a photoreceptor by a cleaning blade. This is because such polymerization toner has a spherical form and a small particle diameter, and easily passes through a small gap between the tip of a cleaning blade and the surface of a photoreceptor. In order to improve cleanability of a polymerization toner, the cleaning blade and the surface of an electrophotographic photoreceptor are improved.

First, improvement of the cleaning blade is explained. In attempting to prevent polymerization toner from passing through a gap between a cleaning blade and a photoreceptor, it is necessary to increase the pressure to the cleaning blade contacted with the surface of the photoreceptor to enhance the cleanability of the cleaning blade. However, when the contact pressure of the cleaning blade is increased, the friction between the cleaning blade and the photoreceptor is increased, and thereby the tip of the cleaning blade is pulled by the photoreceptor in the moving direction of the photoreceptor. Specifically, as illustrated in FIG. 9A, a cleaning blade 62 is pulled by the surface of an electrophotographic photoreceptor 123 in a moving direction (indicated by an arrow) of the photoreceptor due to increase of friction between the blade and the photoreceptor, thereby causing a problem (hereinafter referred to as everted-tip problem) in that an edge line 62c contacting a photoreceptor of a tip 62a of the blade 62 is everted. In this regard, the thus everted tip has a restoring force, and therefore the tip tends to vibrate, resulting in generation of fluttering sounds.

In addition, when the cleaning operation is continued while the edge line 62c contacting a photoreceptor of the cleaning blade 62 is everted, a portion of the tip 62a of the cleaning blade 62, which is apart from the edge line 62c contacting a photoreceptor by few micrometers, is abraded as illustrated in FIG. 9B. When the cleaning blade 62 is further used for the cleaning operation, the portion of the tip 62a of the blade 62 is further abraded, resulting in lack of the edge line 62c contacting a photoreceptor of the blade 62 as illustrated in FIG. 9C. The cleaning blade 62 having no edge line cannot remove residual toner from the surface of the electrophotographic photoreceptor 123, thereby forming an abnormal image in which background thereof is soiled with residual toner.

Japanese Patent No. JP-3602898-B1 discloses a cleaning blade formed of polyurethane elastomer including a surface layer formed of a resin having a pencil hardness of from B to 6H at least at a part contacting an electrophotographic photoreceptor. The surface layer having a pencil hardness of from B to 6H harder than a rubber decreases a friction coefficient of the part to increase abrasion resistance of the cleaning blade. In addition, a friction between the electrophotographic photoreceptor and the cleaning blade is decreased to well prevent the cleaning blade from everting the edge of the electrophotographic photoreceptor. Further, the surface layer having a pencil hardness of from B to 6H is hard and difficult to deform to further prevent the cleaning blade from everting the edge thereof.

Japanese published unexamined application No. JP-2004-233818-A discloses a cleaning blade formed of an elastic blade impregnated with an ultraviolet crosslinkable material including a silicone to be swelled and is exposed to ultraviolet rays such that the ultraviolet crosslinkable material is hardened. The cleaning blade is covered with an ultraviolet crosslinkable material impregnated in the surface of its rubber member. The ultraviolet crosslinkable material harder than the elastic blade covering the surface improves the abrasion resistance and prevents the cleaning blade from everting the edge of the electrophotographic photoreceptor. Further, even when a layer of the ultraviolet crosslinkable material covering the surface of the elastic blade is abraded after used, the part impregnated with the ultraviolet crosslinkable material, which is harder than the rubber member contact the electrophotographic photoreceptor.

However, even when the above-mentioned cleaning blades including a surface layer or a impregnated part are used, occurrence of the above-mentioned problems is hardly prevented if images having a high image area proportion (such as image having large solid images) are continuously produced (i.e., if the amount of residual toner on a photoreceptor to be removed by the cleaning blade is large). The reason is considered to be as follows.

Specifically, since the blade has a cover layer on the tip thereof or includes a crosslinked material in a surface portion thereof in the longitudinal direction thereof, the elastic property of the rubber of the blade tends to deteriorate. When the elastic property of the blade is deteriorated, the blade cannot be satisfactorily contacted with the surface of a photoreceptor (i.e., the pressure of the blade to a photoreceptor varies) if the photoreceptor is eccentric or the surface thereof is waved. In addition, when images having high image area proportions are continuously produced and a large amount of residual toner is present on the surface of the photoreceptor, the large amount of toner is collected at the tip of the blade by being blocked by the blade. In this case, the residual toner at the tip of the blade tends to pass through a relatively large gap formed between a portion of the blade and the surface of the photoreceptor, which are contacted with each other at a relatively low pressure due to eccentricity of the photoreceptor or waving of the surface thereof, resulting in occurrence of the above-mentioned abnormal image problem.

The cleaning blade having only a surface layer having a thick thickness disclosed in Japanese Patent No. JP-3602898-B1 impairs elasticity of the rubber member and deteriorates in followability on the surface of a photoreceptor. Therefore, in order to maintain followability of the cleaning blade on the surface of a photoreceptor, the surface layer needs to have thinner thickness. When the surface layer is thin, the surface layer is abraded in such a short time as the rubber member which is a substrate of the elastic blade is exposed. When the rubber member having low hardness is exposed and directly contacts the surface of a photoreceptor, a friction coefficient between the cleaning blade and the photoreceptor becomes large, resulting in abnormal abrasion and noise.

Japanese Patent No. JP-3602898-B1 discloses the cleaning blade having only a surface layer or an elastic blade impregnated with a resin. Only the surface layer causes the above problem. Only the elastic blade impregnated with a resin does not have such hardness as the surface layer does, resulting in insufficient abrasion resistance. The resin has a pencil hardness of from B to 6H, and even a surface layer including the resin has poor durability. In order to compensate the durability, even when the surface layer is thickened, an attitude control of the edge is impaired and the durability is not improved.

The cleaning blade formed of an elastic blade impregnated with an ultraviolet crosslinkable material and is exposed to ultraviolet rays such that the ultraviolet crosslinkable material is hardened disclosed in Japanese published unexamined application No. JP-2004-233818-A has the following problem. Namely, when the outermost surface of the cleaning blade is formed to have such hardness as a surface layer formed on the surface of the rubber member, the outermost surface needs to be impregnated with such a large amount of the ultraviolet crosslinkable material as covers the surface of the rubber member. An amount of the ultraviolet crosslinkable material penetrated in the rubber member increases as well. When the rubber member including a large amount of the ultraviolet crosslinkable material is irradiated with an UV ray, the impregnated part is formed excessively hard and deep and the elasticity of the rubber member is impaired, resulting in poor followability on the surface of a photoreceptor. When the rubber member includes the ultraviolet crosslinkable material less to maintain followability on the surface of a photoreceptor, the surface of the rubber member cannot be covered with the ultraviolet crosslinkable material. The outermost surface is a substrate of the rubber member mixed with a crosslinked resin and has lower hardness than a surface layer, resulting in a large frictional force between the cleaning blade and the photoreceptor. Therefore, the cleaning blade is likely to evert the edge of the photoreceptor. In addition, a surface layer of the photoreceptor is likely to abrade and abnormal noises are likely to generate.

Japanese published unexamined application No. JP-2004-233818-A discloses a cleaning blade having an elastic blade impregnated with a silicone-containing crosslinked resin with a gradient and covered with the same resin. The cleaning blade has an elastic blade covered with a crosslinked resin impregnating the elastic blade. The silicone-containing crosslinked resin is inferior in durability to an acrylic or a methacrylic resin. Further, when the impregnation is performed for as long as 12 hrs, the crosslinked resin is impregnated too much and the substrate rubber is swelled too much and a network structure of the rubber is broken, resulting in deterioration of mechanical strength and durability.

The depth of the impregnated part can be measured by a method disclosed in Japanese published unexamined application No. JP-2011-138110-A using microscopic IR. The impregnated depth is detected from a ratio of a peak value from the cleaning blade to a peal value of the impregnating material.

Next, improvement of the surface of an electrophotographic photoreceptor is explained.

As a method of preventing the surface layer abrasion and the fluttering sound of a photoreceptor, a combination with a photoreceptor having improved durability is available. As a method of increasing the abrasion resistance of a photoreceptor, methods of forming a crosslinked resin on the surface thereof are disclosed in Japanese published unexamined applications Nos. JP-H01-205171-A, JP-H07-333881-A, JP-H08-15887-A, JP-H08-123053-A, JP-H08-146641-A and JP-2011-145457-A, and Japanese Patents Nos. JP-3734735-B1 and JP-4443837-B1 (Japanese published unexamined applications Nos. JP-2002-341571-A and JP-2004-233881-A).

Methods of forming specific surface profiles on electrophotographic photoreceptors to have pretty good cleanability are disclosed. These stabilize frictional force between the outermost surface of a photoreceptor and a cleaning blade. The cleaning blade edge is stabilized to improve toner cleanability.

A combination of a coating blade and a photoreceptor having a specific surface profile possibly improves toner cleanability. Japanese published unexamined applications Nos. JP-2010-145793-A and JP-2011-145457-A disclose an image forming apparatus combining a photoreceptor having a surface layer having a convex structure and a coating blade. The coating blade stably contacts a photoreceptor with a large pressure to improve toner cleanability. However, in an environment of high-temperature and high-humidity, external additives of a toner such as silica are likely to agglutinate due to moisture in the air. When the agglutinated external additives enter a contact surface between the coating blade and the photoreceptor, they are pressed against the photoreceptor. As a result, the external additives adhere to the surface of the photoreceptor (filming). A part the external additives adhere to absorbs moisture, resulting in abnormal images such as image distortion and blank images.

In order to solve this problem, there is a method of forming fine convexities and concavities on the surface of a photoreceptor and delicately oscillating the cleaning blade edge to scrape the external additives. The blade edge needs to reasonably follow the fine convexities and concavities. Therefore, a cleaning blade using an elastic blade which is not covered with a crosslinked resin is used, but causes cracks on the surface of a photoreceptor at low temperature with a combination of the fine convexities and concavities. When a blade having lower elasticity at low temperature continues to contact the fine convexities and concavities, they are slightly cracked, resulting in large cracks as time passes.

An image forming apparatus cleaning a toner on a photoreceptor without being contaminated in any environment is difficult to prepare.

Because of these reasons, a need exist for an image forming apparatus capable of producing high-quality images having good image resolution, which has a cleaning blade having high abrasion resistance and prevents an external additive of a toner from adhering to a photoreceptor.

### SUMMARY

Accordingly, one object of the present invention is to provide an image forming apparatus capable of producing high-quality images having good image resolution, which has a cleaning blade having high abrasion resistance and prevents an external additive of a toner from adhering to a photoreceptor.

Another object of the present invention is to provide a process cartridge detachable from the image forming apparatus.

These objects and other objects of the present invention, either individually or collectively, have been satisfied by the discovery of the image forming apparatus, including an electrophotographic photoreceptor; and a cleaning blade. The electrophotographic photoreceptor includes an outermost layer having a ten-point average roughness Rz of from 0.5 to 2.4 μm and an average interval between concavities and convexities Sm of from 30 to 300 μm, and the cleaning blade includes a reed-shaped elastic blade having a contact point to the electrophotographic photoreceptor. The contact point includes a substrate; a mixed layer overlying the substrate, including a material forming the substrate and at least one of an acrylic resin and a methacrylic resin and having a thickness not less than 1.0 μm; and a surface layer overlying the mixed layer, including at least one of an acrylic resin and a methacrylic resin and having a thickness not less than 0.1 μm.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGS. 1A and 1B are schematic cross-sectional views illustrating an embodiment of the cleaning blade of the present invention, and FIG. 1A shows the cleaning blade contacts the surface of a photoreceptor and FIG. 1B is an amplified view of an edge line 62c contacting a photoreceptor of the cleaning blade 62 to a photoreceptor;

FIG. 2 is a schematic perspective view illustrating an example of the cleaning blade of the present invention;

FIGS. 3A to 3B are schematic views illustrating embodiments of photosensitive layer of photoreceptors use in the image forming apparatus of the present invention, and FIG. 3A is an embodiment in which an outermost layer is a photosensitive layer and FIG. 3B is an embodiment in which an outermost layer is a protection layer;

FIG. 4 is a schematic cross-sectional view illustrating an embodiment of the image forming apparatus of the present invention;

FIG. 5 is a schematic cross-sectional view illustrating an image forming unit of the image forming apparatus illustrated in FIG. 4;

FIGS. 6A and 6B are schematic views for explaining a way to determine a circularity of a toner;

FIG. 7 is a schematic view for explaining a way to determine a width of an abraded portion of an elastic blade;

FIG. 8 is a schematic view for explaining differences between a cleaning blade of the present invention and a comparative cleaning blade; and

FIGS. 9A to 9C are schematic views for explaining how a cleaning blade is damaged.

### DETAILED DESCRIPTION

The present invention provides an image forming apparatus capable of producing high-quality images having good image resolution, which has a cleaning blade having high abrasion resistance and prevents an external additive of a toner from adhering to a photoreceptor.

### <Electrophotographic Photoreceptor>

The electrophotographic photoreceptor includes a substrate, a photosensitive layer on the substrate and an outermost layer having a ten-point average roughness Rz of from 0.5 to 2.4 μm and an average interval between concavities and convexities Sm of from 30 to 300 μm.

The electrophotographic photoreceptor of the present invention is not particularly limited in its layer composition, and includes at least a substrate and a photosensitive layer on the substrate, and may include an undercoat layer or a protection layer when necessary,

FIG. 3A is an embodiment of the layer composition of the electrophotographic photoreceptor of the present invention, in which a photosensitive layer 22 is formed on a substrate 21, the photosensitive layer 22 is a functionally-separated layer including a charge generation layer 25 and a charge transport layer 26, and an undercoat layer 24 is formed between the substrate 21 and the photosensitive layer 22. The undercoat layer 24 may not be formed.

In the electrophotographic photoreceptor in FIG. 3B, a photosensitive layer 22 is formed on a substrate 21, a protection layer 28 having good abrasion resistance is formed on an outermost surface, the photosensitive layer 22 is a functionally-separated layer including a charge generation layer 25 and a charge transport layer 26, and an undercoat layer 24 is formed between the substrate 21 and the photosensitive layer 22. The undercoat layer 24 may not be formed.

### <<Outermost Layer>>

The outermost layer of the electrophotographic photoreceptor has a ten-point average roughness Rz of from 0.5 to 2.4 μm, and preferably from 0.7 to 1.5 μm, and an average interval between concavities and convexities Sm of from 30 to 300 μm, and preferably from 50 to 200 μm. This enables the electrophotographic photoreceptor to have high cleanability. When the outermost layer is a protection layer on the photosensitive layer, the electrophotographic photoreceptor has high abrasion resistance and cleanability.

When the outermost layer has a ten-point average roughness Rz of from 0.5 to 2.4 μm and an average interval between concavities and convexities Sm of from 30 to 300 μm, the blade nip has a suitable contact area and a frictional force between the blade and the outermost layer is stabilized.

When the outermost layer does not have a ten-point average roughness Rz of from 0.5 to 2.4 μm and an average interval between concavities and convexities Sm of from 30 to 300 μm, the blade nip has an unstable contact area and a frictional force between the blade and the outermost layer is destabilized. An external additive of a toner such as silica is pressed against the outermost layer of the photoreceptor by a cleaning blade edge surface layer having high hardness and adheres to the photoreceptor, i.e., causes filming. In addition, toner cleanability deteriorates.

Rz and Sm are measured according to JIS B0601: '01, using SURFCOM 1400D from TOKYO SEIMITSU.

The surface profile can be controlled by sand blast after coated, an amount of filler and dispersion status thereof when included in a coating liquid, or viscosity of a coating liquid. When an outermost layer is formed by spray coating, coating conditions such as a discharge pressure, a distance from a photoreceptor, a rotational speed thereof and an oscillate speed can control the surface profile.

An uncoated cleaning blade is likely to have low followability to fine concavities and convexities. The contact point of the elastic blade of the present invention includes a substrate; a mixed layer overlying the substrate, including a material forming the substrate and at least one of an acrylic resin and a methacrylic resin; and a surface layer overlying the mixed layer, including at least one of an acrylic resin and a methacrylic resin. The blade edge is hard, has a stable frictional force with the outermost layer, and continuous material compositions to the substrate. Therefore, the blade has good power transmission and is thought to follow ne concavities and convexities. Further, the blade edge has high hardness, which prevents the edge from cracking at low temperature.

### <<Protection Layer>>

The outermost layer may be a protection layer formed on a photosensitive layer. The protection layer largely improves abrasion resistance of a photoreceptor.

In the present invention, it is preferable that the outermost layer of a photoreceptor is a protection layer including a filler. In addition to an effect of fine concavities and convexities, there is an effect of a difference of frictional force between the cleaning blade and the outermost layer in a microscopic area including the filler. The area including the filler and having high hardness and the blade edge have a large difference in hardness, which is thought to induce slight oscillation of the edge. This increases an effect of scrape, which is thought to prevent the external additive from adhering. The filler harder than a filler exerts the effect more than the resin, and metal oxides are preferably used among the fillers.

Specific examples of the filler included in the protection layer include polyethylene, PMMA, particulate fluorine resins such as PTFE and PFA, particulate silicone resins, silica, particulate metal oxides, etc. The particulate metal oxides improve abrasion resistance in addition to the slight oscillation effect. Specific examples of the particulate metal oxides include titanium oxide, silica, tin oxide, alumina, zirconium oxide, indium oxide, calcium oxide, zinc oxide, etc. The surface of the particulate metal oxide may be treated with an organic or an inorganic material. The organic material includes silane coupling agents, fluorine silane coupling agents, higher fatty acids, etc. The inorganic material includes alumina, zirconia, tin oxide, silica, etc. The particulate metal oxide is pulverized, dispersed and mixed with a coating liquid to be coated.

A protection layer including the filler in an amount of from 10 to 40% by volume improves in contamination resistance. When less than 10% by volume, the contamination resistance slightly deteriorates in some cases. This is because the slight oscillation of the blade edge is thought to decrease. When greater than 40% by volume, concavities and convexities on the surface of a photoreceptor extremely increase and the cleaning blade cannot stably hold its edge thereon, resulting in occasional deterioration of cleanability.

The content of a filler in a protection layer can be determined by observing a cross-section thereof with FE-SEM at 10.000-fold magnifications.

Specific examples of resins for use in the protection layer include, but are not limited to, polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins, etc. These polymers can be used alone or in combination. In addition, copolymers of the monomers of the polymer materials mentioned above can also be used. Further, copolymers of the monomers with a charge transport material can also be used.

A hardening resin formed of a polymerized polymerizable compound is preferably used in terms of abrasion resistance. The polymerizable compound including two or more polymerizable functional groups in its molecule is preferably used in terms of mechanical durability. Namely, a di- or more functional polymerizable compound is polymerized to develop a 3D network, and a protection layer having very high crosslink density (abrasion resistance) and high elasticity (scratch resistance) is formed.

Specific examples of the hardening resin include, but are not limited to, amino resins, urethane resins, epoxy resins, phenol resins, silicone resins, acrylic resins, etc. Among these, UV hardening acrylic resins including a tri- or more functional radical polymerizable monomer are preferably used in terms of abrasion resistance. Among these, a polymerizable compound having an equivalent molecular weight not greater than 350 is more preferably used because of particularly developing a 3D network.

Specific examples of the tri- or more functional radical polymerizable monomer having an equivalent molecular weight not greater than 350 include trimethylolpropane triacrylate (TMPTA), trimethylolpropane trimethacrylate, trimethylolpropanealkylene-modified triacrylate, trimethylolpropaneethyleneoxy-modified (hereafter EO-modified) triacrylate, trimethylolpropanepropyleneoxy-modified (hereafter PO-modified) triacrylate, trimethylolpropanecaprolactone-modified triacrylate, trimethylolpropanealkylene-modified trimethacrylate, pentaerythritol triacrylate, pentaerythritol tetracrylate (PETTA), glycerol triacrylate, glycerol epichlorohydrin-modified (hereafter ECH-modified) triacrylate, glycerol EO-modified triacrylate, glycerol PO-modified triacrylate, tris(acryloxyethyl)isocyanurate, dipentaerythritol hexaacrylate (DPHA), dipentaerythritolcaprolactone-modified hexaacrylate, dipentaerythritolhydroxy pentaacrylate, alkylated dipentaerythritol pentacrylate, alkylated dipentaerythritol tetraacrylate, alkylated dipentaerythritol triacrylate, dimethylolpropane tetraacrylate (DTMPTA), pentaerythritolethoxy tetraacrylate, etc. These can be used alone or in combination.

The protection layer may include a charge transportable compound (preferably having a polymerizable functional group in terms of mechanical durability when necessary) in addition to the polymerizable compound. The charge transportable compound having a polymerizable functional group preferably has less functional groups in terms of distortion of the hardening resin and inner stress of the crosslinked surface layer, and a monofunctional charge transportable compound is preferably used.

Solvents used in a protection layer coating liquid include ketones, ethers, aromatic compounds, halogen compounds, esters, etc. Methyl ethyl ketone, tetrahydrofuran and cyclohexanone are more preferably used than chlorobenzene, dichloromethane, toluene and xylene because of their low environmental load.

The coating liquid may include a polymerization initiator such as a heat polymerization initiator and a photopolymerization initiator when necessary to efficiently proceed the hardening reaction.

Specific examples of the heat polymerization initiator include peroxide initiators such as 2,5-dimethylhexane-2,5-dihydrooxide, dicumylperoxide, benzoylperoxide, t-butylcumylperoxide, 2,5-dimethyl-2,5-di(peroxybenzoyl)hexyne-3, di-t-butylbeloxide, t-butylhydrobeloxide, cumenehydrobeloxide and lauroylperoxide; and azo initiators such as azobisisobutylnitrile, azobiscyclohexanecarbonitrile, azobisisomethylbutyrate, azobisisobutylamidinehydrorchloride and 4,4′-azobis-4-cyanovaleric acid.

Specific examples of the photopolymerization initiator include acetone or ketal photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-molpholinophenyl)butanone-1,2-hydroxy-2-methyl-1-phenylpropane-1-one and 1-phenyl-1,2-propanedion-2-(o-ethoxycarbonyl)oxime; benzoinether photopolymerization initiators such as benzoin, benzoinmethylether, benzomethylether, benzoinisobutylether and benzoinisopropylether; benzophenone photopolymerization initiators such as benzophenone, 4-hydroxybenzophenone, o-benzoylmethylbenzoate, 2-benzoylnaphthalene, 4-benzoylviphenyl, 4-benzoylphenylether, acrylated benzophenone and 1,4-benzoylbenzene; thioxanthone photo polymerization initiators such as 2-isopropylthioxanthone, 2-chlorothioxanthone, 2,4-dimethylthioxanthone, 2,4-diethylthioxanthone and 2,4-dichlorothioxanthone; and other photopolymerization initiators such as ethylanthraquinone, 2,4,6-trimethylbenzoyldiphenylphosphineoxide, 2,4,6-trimethylbenzoyldiphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds and imidazole compounds. Further, a material having a photo polymerizing effect can be used alone or in combination with the above-mentioned photopolymerization initiators. Specific examples of the materials include triethanolamine, methyldiethanol amine, 4-dimethylaminoethylbenzoate, 4-dimethylaminoisoamylbenzoate, ethyl(2-dimethylamino)benzoate and 4,4-dimethylaminobenzophenone.

The protection layer preferably includes the polymerization initiators in an amount of 0.5 to 40 parts by weight, and more preferably from 1 to 20 parts by weight per 100 parts by weight of the radical polymerizable compounds.

The protection layer may further include low-molecular-weight compounds such as an antioxidant, a plasticizer, a lubricant and an UV absorber, and a leveling agent. These can be used alone or in combination.

The protection layer preferably includes the low-molecular-weight compounds in an amount of from 0.1 to 50 parts by weight, and more preferably from 0.1 to 20 parts by weight per 100 parts by weight of the resin. The protection layer preferably includes the leveling agent in an amount of from 0.001 to 5 parts by weight per 100 parts by weight of the resin.

The protection layer is formed by a dip coating method, a spray coating method, a ring coat method, a roll coater method, a gravure coating method, a nozzle coating method, a screen printing method, etc., and is hardened with an external energy.

The external energy is selected from heat, light and radiation according to a resin used.

Specific examples of methods applying heat energy include, but are not limited to, a gaseous body such as nitrogen, a steam, a variety of heating media, infrared or an electromagnetic wave to the layer from the coated side or from the substrate. The heating temperature is preferably from 100 to 170° C. When less than 100° C., the reaction speed is low and the hardening reaction is not completely finished in some cases. When higher than 170° C., the hardening reaction unevenly proceeds, resulting in occasional large distortions, many unreacted residues or reaction-ceased end in the protection layer.

In order to evenly proceed the hardening reaction, the protection layer is effectively heated at a temperature less than 100° C. and further heated at a temperature not less than 100° C. to complete the reaction.

An UV irradiation light source such as a high pressure mercury lamp or a metal halide lamp having a light emission wavelength mainly in ultraviolet light can be utilized. In addition, a visible light source adaptable to absorption wavelength of the radical polymerizing compounds and photo polymerization initiators can also be used. An irradiation light amount is preferably from 50 to 1,000 mW/cm². When less than 50 mW/cm², the curable reaction takes time. When greater than 1,000 mW/cm², the reaction nonuniformly proceeds, resulting in local wrinkles on the surface of crosslinked surface layer, and generation of a number of unreacted residues and reaction-ceased ends.

Further, the rapid crosslinking enlarges an internal stress, resulting in cracks and peeling of the layer. Radiation energy includes an electron beam.

Heat and light energies can effectively be used because of reaction speed control and simple devices.

The protection layer preferably has a thickness o from 0.5 to 10 μm, and more preferably from 0.8 to 5 nm in terms of durability and image resolution.

### <<Photosensitive Layer>>

A multilayered photosensitive layer including layered charge generation and transport layers is preferably used.

### —Charge Generation Layer—

A charge generation layer is a part of the multilayered photosensitive layer, generating a charge when irradiated and including a charge generation material as a main component and a binder resin when necessary.

### —Charge Generation Material—

Inorganic materials and organic materials can be used as the charge generation material.

Specific examples of the inorganic materials include crystalline selenium, amorphous selenium, selenium-tellurium alloys, selenium-tellurium-halogen alloys, selenium-arsenic alloys and amorphous silicone. The amorphous silicone prepared by terminating a dangling bond with a hydrogen atom or a halogen atom, or doping a boron atom or a phosphorus atom.

Specific examples of the organic charge generation materials include, but are not limited to metal phthalocyanine such as titanylphthalocyanine and chlorogallium phthalocyanine, metal-free phthalocyanine, azulenium pigments, squaric acid methine pigments, symmetric or asymmetric azo pigments having a carbazole skeleton, symmetric or asymmetric azo pigments having a triphenylamine skeleton, symmetric or asymmetric azo pigments having a diphenylamine skeleton, symmetric or asymmetric azo pigments having a dibenzothiophene skeleton, symmetric or asymmetric azo pigments having a fluorenone skeleton, symmetric or asymmetric azo pigments having an oxadiazole skeleton, symmetric or asymmetric azo pigments having a bisstilbene skeleton, symmetric or asymmetric azo pigments having a distyryloxadiazole skeleton, symmetric or asymmetric azo pigments having a distyrylcarbazole skeleton, perylene pigments, anthraquinone pigments, polycyclic quinone pigments, quinoneimine pigments, diphenyl methane pigments, triphenyl methane pigments, benzoquinone pigments, naphthoquinone pigments, cyanine pigments, azomethine pigments, indigoid pigments, bisbenzimidazole pigments and the like materials. These charge generation materials can be used alone or in combination.

Among these materials, the metal phthalocyanine, symmetric or asymmetric azo pigments having a fluorenone skeleton, symmetric or asymmetric azo pigments having a triphenylamine skeleton and perylene pigments are preferably used because they all have high charge generation quantum efficiency.

Specific examples of the binder resin used in the charge generation layer when necessary include polyamide resins, polyurethane resins, epoxy resins, polyketone resins, polycarbonate resins, silicone resins, acrylic resins, polyvinyl butyral resins, polyvinyl formal resins, polyvinyl ketone resins, polystyrene resins, poly-N-vinylcarbazole resins, polyacrylamide resins, and the like resins. These resins can be used alone or in combination. Among these resins, the polyvinyl butyral resins are mostly and preferably used.

Suitable methods for forming the charge generation layer are broadly classified into thin film forming methods in a vacuum and casting methods.

Specific examples of the former thin film forming methods in a vacuum include vacuum evaporation methods, glow discharge decomposition methods, ion plating methods, sputtering methods, reaction sputtering methods, CVD (chemical vapor deposition) methods, and the like methods. A layer of the above-mentioned inorganic and organic materials can be formed by one of these methods.

The casting methods for forming the charge generation layer typically include the following steps:

(1) preparing a coating liquid by mixing one or more inorganic or organic charge generation materials mentioned above with a solvent such as tetrahydrofuran, cyclohexanone, dioxane, dichloroethane, butanone and the like, optionally together with a binder resin and an additive, and then dispersing the materials with a ball mill, an attritor, a sand mill or the like, to prepare a charge generation layer coating liquid;

(2) coating the charge generation layer coating liquid, which is diluted if necessary, on a substrate by a method such as dip coating, spray coating and bead coating; and

(3) drying the coated liquid to form a charge generation layer.

The charge generation layer preferably has a thickness of from about 0.01 to about 5 μm, and more preferably from about 0.05 to about 2 μm.

### —Charge Transport Layer—

The charge transport layer is a part of the multilayered photosensitive layer, which receives a charge generated in the charge generation layer, and transports the charge to a surface of a photoreceptor to neutralize a charge thereof. Main components of the charge transport layer are a charge transport material, a binder component and other components when necessary.

The charge transport layer can be formed by dissolving or dispersing a mixture or a copolymer mainly formed of a charge transport material and a binder resin in a solvent to prepare a coating liquid; and coating and drying the coating liquid.

Suitable coating methods include a dip coating method, a spray coating method, a ring coating method, a roll coating method, a gravure coating method, a nozzle coating method and a screen printing method.

The charge transport layer preferably has a thickness of from 15 to 40 μm, and more preferably from 15 to 30 μm to have practically required sensitivity and chargeability, and most preferably from 15 to 25 μm when image resolution is required.

When a protection layer is formed on the charge transport layer, the charge transport layer need not be designed in consideration of abrasion in practical use, and can be thin.

Suitable solvents for use in the charge transport layer coating liquid include ketone such as methyl ethyl ketone, acetone, methyl isobutyl ketone, and cyclohexanone; ethers such as dioxane, tetrahydrofuran, and ethyl cellosolve; aromatic solvents such as toluene, and xylene; halogen-containing solvents such as chlorobenzene, and dichloromethane; esters such as ethyl acetate and butyl acetate; etc. These solvents can be used alone or in combination.

Particularly, methyl ethyl ketone, tetrahydrofuran and cyclohexanone are more preferably used than chlorobenzene, dichloromethane, toluene and xylene because of their low environmental burdens.

### —Binder Component—

Specific examples of the polymers for use as the binder resin of the charge transport layer 113 include thermoplastic resins and thermosetting resins such as polystyrene, styrene/acrylonitrile copolymers, styrene/butadiene copolymers, styrene/maleic anhydride copolymers, polyester, polyvinyl chloride, vinyl chloride/vinyl acetate copolymers, polyvinyl acetate, polyvinylidene chloride, polyarylate, polycarbonate, cellulose acetate resins, ethyl cellulose resins, polyvinyl butyral, polyvinyl formal, polyvinyl toluene, acrylic resins, silicone resins, fluorine-containing resins, epoxy resins, melamine resins, urethane resins, phenolic resins and alkyd resins.

These polymer materials can be used alone or in combination. In addition, copolymers of the monomers of the polymer materials mentioned above can also be used. Further, copolymers of the monomers with a charge transport material can also be used.

Particularly, polystyrene, polyester, polyarylate and polycarbonate are preferably used as a binder of a charge transport material because of their good charge transportability.

Therefore, such a polystyrene resin as has low mechanical strength although having high transparency, which has conventionally been difficult to use, can also be used effectively as the binder resin in the charge transport layer.

### —Charge Transport Materials—

Charge transport materials include electron transport materials and positive hole transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, and benzoquinone derivatives.

Specific examples of the positive hole transport materials include electron donating materials such as oxazole derivatives, oxadiazole derivatives, imidazole derivatives, triphenylamine derivatives, 9-(p-diethylaminostyrylanthracene), 1,1-bis(4-dibenzylaminophenyl)propane, styrylanthracene, styrylpyrazoline, phenylhydrazone compounds, α-phenylstilbene derivatives, thiazole derivatives, triazole derivatives, phenazine derivatives, acridine derivatives, benzofuran derivatives, benzimidazole derivatives, thiophene derivatives, and the like materials.

Specific examples of the positive hole transport materials include poly-N-carbazole or its derivatives, poly-γ-carbazolylethylglutamate or its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, etc.

These charge transport materials can be used alone or in combination.

The charge transport layer can include one or more low-molecular-weight compounds such as antioxidants, plasticizers, lubricants and ultraviolet absorbents, and leveling agents when necessary.

When the low-molecular-weight compounds and the are leveling agents are used together, the sensitivity occasionally deteriorates.

Therefore, the low-molecular-weight compounds are preferably included therein in an amount of from 0.1 to 20 parts by weight, and more preferably from 0.1 to 10 parts by weight. The leveling agents are included therein in an amount of from 0.001 to 0.1 parts by weight

### <<Substrate>>

Suitable materials for use as the substrate include materials having a volume resistance not greater than 10¹⁰ Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tin oxides, indium oxides and the like, is deposited or sputtered. In addition, a plate of a metal such as aluminum, aluminum alloys, nickel and stainless steel and a metal cylinder, which is prepared by tubing a metal such as the metals mentioned above by a method such as impact ironing or direct ironing, and then treating the surface of the tube by cutting, super finishing, polishing and the like treatments, can be also used as the substrate. Further, endless belts of a metal such as nickel and stainless steel, which have been disclosed in Japanese published unexamined application No. JP-S52-36016-A can be also used as the substrate.

The substrate may be coated with an electroconductive powder dispersed in a binder resin.

Specific examples of the electroconductive powder include, but are not limited to, carbon powders such as carbon black and acetylene black; metallic powders such as aluminium, nickel, iron, nichrome, copper, zinc, and silver; or metallic oxides such as electroconductive titanium oxide, electroconductive tin oxide and ITO. Specific examples of the binder resins include, but are not limited to, polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate, polycarbonate, cellulose acetate resins, ethyl cellulose resins, polyvinyl butyral, polyvinyl formal, polyvinyl toluene, poly-N-vinyl-carbazole, acrylic resins, silicone resins, fluorine-containing resins, epoxy resins, melamine resins, urethane resins, phenolic resins and alkyd resins. These can be used alone or in combination.

The electroconductive powder and the binder resin are dispersed in a solvent such as tetrahydrofuran, dichloromethane, methyl ethyl ketone and toluene.

A heat contraction tube including the electroconductive powder and a material such as polyvinylchloride, polypropylene, polyester, polystyrene, polyvinylidene, polyethylene, rubber chloride and Teflon (registered trade name) can also be used as a substrate.

### <<Undercoat Layer>>

Further, a photoreceptor for use in the image forming apparatus of the present invention can include an undercoat layer between its substrate and photosensitive layer when necessary.

The undercoat layer typically includes a resin as a main component. However, since a photosensitive layer is typically formed on the undercoat layer by coating a liquid including an organic solvent, the resin in the undercoat layer preferably has good resistance against typical organic solvents.

Specific examples of such resins include water-soluble resins such as polyvinyl alcohol resins, casein and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins, etc.

The undercoat layer may include a fine powder of metal oxides such as titanium oxide, silica, alumina, zirconium oxide, tin oxide and indium oxide; metal sulfides; and metal nitrides as a filler to maintain more stable chargeability of the resultant photoreceptor.

The undercoat layer can be formed by coating a coating liquid using a proper solvent and a proper coating method, and preferably has a thickness of from 0 to 10 μm, and more preferably from 0.2 to 6 μm.

In the photoreceptor of the present invention, an intermediate layer may be formed between the substrate and the undercoat layer. The intermediate layer includes a resin as a main component. The resin preferably has insolubility in an organic solvent in consideration of a photosensitive layer formed thereon with a solvent. The resin can be the same as those of the undercoat layer.

In the photoreceptor of the present invention, antioxidants, plasticizers, lubricants, ultraviolet absorbents low-molecular-weight charge transport materials and leveling agents can be included in each layer such as the charge generation layer, the charge transport layer, the undercoat layer and protection layer for environmental improvement, above all for the purpose of preventing decrease of photosensitivity and increase of residual potential.

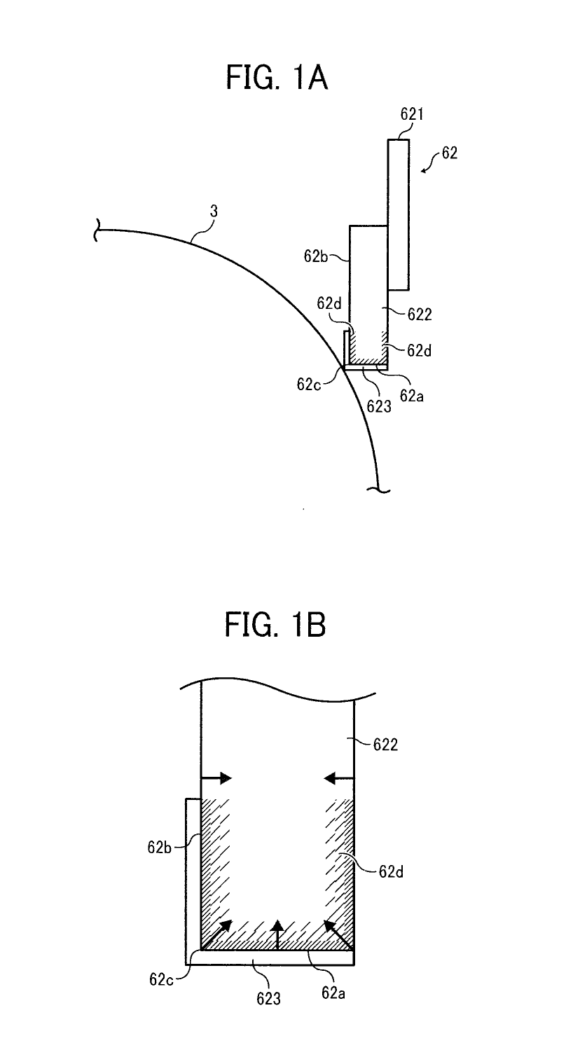

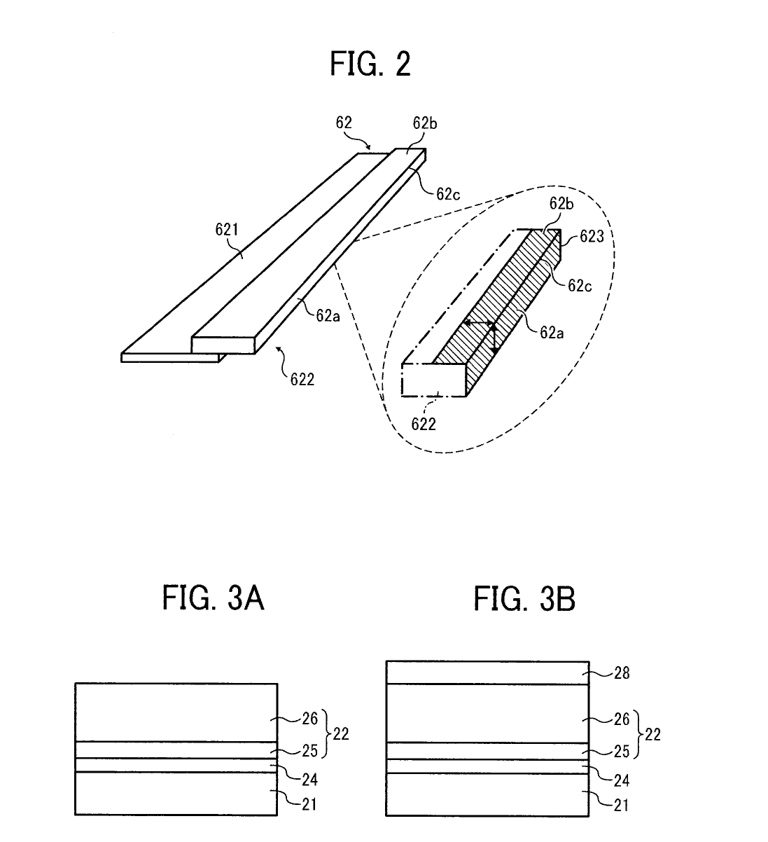

FIG. 2 is a schematic perspective view illustrating an example of the cleaning blade of the present invention. FIGS. 1A and 1B are schematic cross-sectional views illustrating an embodiment of the cleaning blade of the present invention, and FIG. 1A shows the cleaning blade contacts the surface of a photoreceptor and FIG. 1B is an amplified view of an edge line 62c contacting a photoreceptor of the cleaning blade 62 to a photoreceptor.

The cleaning blade 62 includes a reed-shaped holder 621 which is made of a rigid material such as metals and hard plastics, and a reed-shaped elastic blade 622.

The elastic blade 622 has an edge line 62c contacting a photoreceptor, which has a layered structure formed of a substrate; a mixed layer formed of a material forming the substrate and an acrylic and/or a methacrylic resin, which has a thickness not less than 1.0 μm; and a surface resin layer formed of acrylic and/or a methacrylic resin, which has a thickness not less than 0.1 μm. The mixed layer and the surface resin layer are preferably formed on the whole area of the edge line 62c contacting a photoreceptor. The edge line 62c contacting a photoreceptor possibly extends and the layered structure is preferably formed wider than the initial edge line 62c contacting a photoreceptor.

The elastic blade 622 is fixed to an upper end portion of the holder 621, for example, by an adhesive.

In order that the elastic blade 622 can be satisfactorily contacted with the surface of the photoreceptor 3 even if the photoreceptor 3 is eccentric or the surface thereof is waved, the elastic blade 622 preferably has a high resilience coefficient. Typical synthetic rubbers such as an acrylic rubber, a nitrile rubber, an isoprene rubber, a urethane rubber, an ethylene propylene rubber, a chlorosulfonated polyethylene rubber, an epichlorohydrine rubber, a chloroprene rubber, a silicone rubber, a styrene-butadiene rubber, a butadiene rubber and a fluoro-rubber are used. Rubbers having a urethane group such as urethane rubbers are preferably used therefor.

The elastic blade 622 preferably has a substrate having a hardness of from 55 to 85° at 25° C. in terms of abrasion resistance, and a repulsion elasticity of form 10 to 60% at 25° C. in terms of followability to fine concavities and convexities.

The mixed layer formed of the substrate and the acrylic and/or the methacrylic resin is preferably formed by impregnating the elastic blade 622 with an acrylic and/or a methacrylic crosslinkable resin solution using a coating method such as brush coating, spray coating and dip coating, and crosslinking the acrylic and/or a methacrylic monomer. The acrylic and/or a methacrylic monomer is crosslinked when applied with an energy such as a heat, light and an electron beam.

Solvents used to form the protection layer can be used in the acrylic and/or a methacrylic crosslinkable resin solution, and a polymerization initiator may be included therein as it is in the protection layer.

Specific examples of the acrylic and/or methacrylic monomer for use in the present invention include trimethylolpropane triacrylate (TMPTA), trimethylolpropane trimethacrylate, trimethylolpropanealkylene-modified triacrylate, trimethylolpropaneethyleneoxy-modified (hereafter EO-modified) triacrylate, trimethylolpropanepropyleneoxy-modified (hereafter PO-modified) triacrylate, trimethylolpropanecaprolactone-modified triacrylate, trimethylolpropanealkylene-modified trimethacrylate, pentaerythritol triacrylate, pentaerythritol tetracrylate (PETTA), glycerol triacrylate, glycerol epichlorohydrin-modified (hereafter ECH-modified) triacrylate, glycerol EO-modified triacrylate, glycerol PO-modified triacrylate, tris(acryloxyethyl)isocyanurate, dipentaerythritol hexaacrylate (DPHA), dipentaerythritolcaprolactone-modified hexaacrylate, dipentaerythritolhydroxy pentaacrylate, alkylated dipentaerythritol pentacrylate, alkylated dipentaerythritol tetraacrylate, alkylated dipentaerythritol triacrylate, dimethylolpropane tetraacrylate (DTMPTA), pentaerythritolethoxy tetraacrylate, phosphoric acid EO-modified triacrylate, and 2,2,5,5-tetrahydroxymethylcyclopentanone tetracrylate. These can be used alone or in combination.

After the elastic blade 622 is impregnated with an acrylic and/or a methacrylic crosslinkable resin liquid, followed by natural drying for a predetermined period, the surface layer 623 is formed on the surface of the resin-impregnated portion of the blade using a method such as spray coating, dip coating, and screen printing to cover the edge line 62c and the surface of a tip portion of the elastic blade 622. Thus, the elastic blade 622 is impregnated with an acrylic and/or a methacrylic crosslinkable resin liquid to form a mixed layer 62d including the substrate and the acrylic and/or methacrylic resin at the surface thereof, and an acrylic and/or a methacrylic resin layer is formed then. A heat or a light energy may be applied after the elastic blade is impregnated with the acrylic and/or methacrylic crosslinkable resin liquid for a predetermined time or after the acrylic and/or methacrylic resin layer is formed to crosslink the resin.

The cleaning blade 62 can prevent the edge line 62c of the elastic blade 622 from deforming in a surface travel direction of the photoreceptor 3 because of the acrylic and/or methacrylic resin surface layer 623 contacting thereto. Further, even when the acrylic and/or methacrylic resin surface layer 623 is worn out and the substrate and the acrylic and/or methacrylic resin mixed layer 62d formed by impregnation treatment is exposed, the mixed layer can prevent the edge line 62c from deforming as well.

The thickness of the mixed layer 62d including the substrate and the acrylic and/or methacrylic resin can be controlled by the acrylic and/or methacrylic monomer, solvent, solid contents concentration, impregnation time, temperature, etc.

The mixed layer 62d including the substrate and the acrylic and/or methacrylic resin preferably has a thickness of from 5 to 100 μm, and more preferably from 10 to 30 μm. When too thin, the cleaning blade 62 is difficult to prevent the edge line 62c from deforming for long periods. When too thick, the cleaning blade has larger hardness to increase the load to a photoreceptor, resulting in increase of abrasion thereof and generation of fluttering sounds at low temperature. Further, the cleaning blade is likely to have a microscopic crack.

The substrate and the acrylic and/or methacrylic resin mixed layer 62d can be formed when the when the acrylic and/or methacrylic resin surface layer 623 is formed. In this case, the mixed layer 62d often has a thickness of the measurement limit or less. When having a thickness less than 1 μm, the substrate and the acrylic and/or methacrylic resin mixed layer 62d does not exert the effect of the present invention.

The thickness of the mixed layer including the substrate and the acrylic and/or methacrylic resin can be measured by a method disclosed in Japanese published unexamined application No. JP-2011-138110-A using microscopic IR.

The acrylic and/or methacrylic resin surface layer 623 can be formed while the blade is dipped in an acrylic and/or a methacrylic crosslinkable resin liquid for a predetermined time, but the layer occasionally has a thin thickness. Therefore, after dipped in the acrylic and/or methacrylic crosslinkable resin liquid for a predetermined time to form the mixed layer including the substrate and the acrylic and/or methacrylic resin, the acrylic and/or methacrylic crosslinkable resin liquid is preferably coated on the mixed layer to form the acrylic and/or methacrylic resin layer thereon.

The acrylic and/or methacrylic resin surface layer 623 is formed by coating the same acrylic and/or methacrylic monomers as those of the impregnating materials and applying an energy such as a heat, light and an electron beam.

The acrylic and/or methacrylic resin surface layer 623 preferably has a thickness not less than 0.1 μm, and more preferably from 0.5 to 1.0 μm. When too thin, the cleaning blade does not have followability on the surface of a photoreceptor. When too thick, the cleaning blade edge has everted-tip and crack problems when used for long periods.

When having a thickness less than 0.1 μm, the acrylic and/or methacrylic resin surface layer does not exert the effect of the present invention.

The thickness of the acrylic and/or methacrylic resin surface layer 623 can be measured by cutting the cross-section to take a picture thereof with a scanning electron microscope or a transmission electron microscope.

### <Image Forming Apparatus>

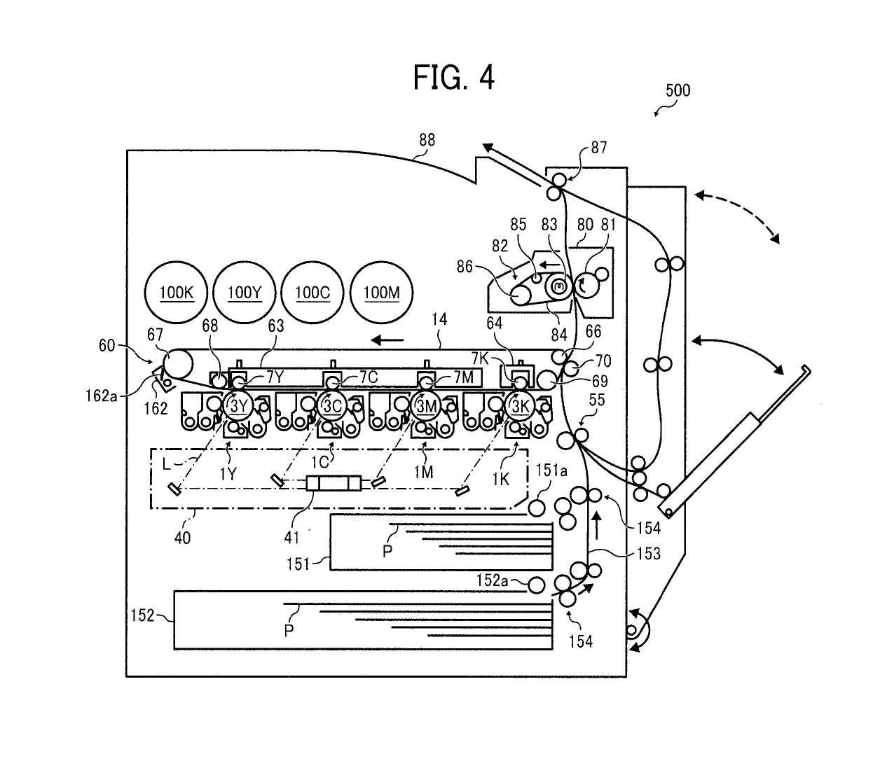

An embodiment of the image forming apparatus of the present invention is explained by reference to drawings. FIG. 4 illustrates an electrophotographic printer 500 as embodiment of the image forming apparatus of the present invention.

Referring to FIG. 4, a printer 500 includes four image forming units, i.e., yellow (Y), cyan (C), magenta (M) and black (K) image forming units 1Y, 1C, 1M and 1K. The four image forming units 1Y, 1C, 1M and 1K have the same configuration except that the color of toner used for developing an electrostatic latent image on a photoreceptor is different.

The printer 500 further includes a transfer unit 60, which includes an intermediate transfer belt 14 and which is located above the four image forming units 1. As mentioned later in detail, Y, C, M and K toner images formed on respective photoreceptors 3Y, 3C, 3M and 3K serving as photoreceptors are transferred onto the surface of the intermediate transfer belt 14 so as to be overlaid, resulting in formation of a combined color toner image on the intermediate transfer belt 14.

In addition, an optical writing unit 40 serving as a latent image former is located below the four image forming units 1. The optical writing unit 40 emits light beams L (such as laser beams) based on Y, C, M and K image information to irradiate the photoreceptors 3Y, 3C, 3M and 3K with the laser beams L, thereby forming electrostatic latent images, which respectively correspond to the Y, C, M and K images to be formed, on the photoreceptors. The optical writing unit 40 includes a polygon mirror 41, which is rotated by a motor and which reflects the light beams L emitted by a light source of the optical writing unit while deflecting the laser beams to irradiate the photoreceptors 3Y, 3C, 3M and 3K with the laser beams L via optical lenses and mirrors. The optical writing unit 40 is not limited thereto, and an optical writing unit using a LED array or the like can also be used therefor.

Below the optical writing unit 40, a first sheet cassette 151, and a second sheet cassette 152 are arranged so that the first sheet cassette is located above the second sheet cassette. Each of the sheet cassettes 151 and 152 contains a stack of paper sheets P serving as a recording material. Uppermost sheets of the paper sheets P in the first and second sheet cassettes 151 and 152 are contacted with a first feed roller 151a and a second feed roller 152a, respectively. When the first feed roller 151a is rotated (counterclockwise in FIG. 4) by a driver (not shown), the uppermost sheet P in the first sheet cassette 151 is fed by the first feed roller 151a toward a sheet passage 153 located on the right side of the printer 500 while extending vertically. Similarly, when the second feed roller 152a is rotated (counterclockwise in FIG. 4) by a driver (not shown), the uppermost sheet P in the second sheet cassette 152 is fed by the second feed roller 152a toward the sheet passage 153.

Plural pairs of feed rollers 154 are arranged in the sheet passage 153. The paper sheet P fed into the sheet passage 153 is fed from the lower side of the sheet passage 153 to the upper side thereof while being pinched by the pairs of feed rollers 154.

A pair of registration rollers 55 is arranged on the downstream side of the sheet passage 153 relative to the sheet feeding direction. When the pair of registration rollers 55 pinches the tip of the paper sheet P thus fed by the pairs of feed rollers 154, the pair of registration rollers 55 is stopped once, and is then rotated again to timely feed the paper sheet P to a secondary transfer nip mentioned below so that a combined color toner image on the intermediate transfer belt 14 is transferred onto the predetermined position of the paper sheet P.

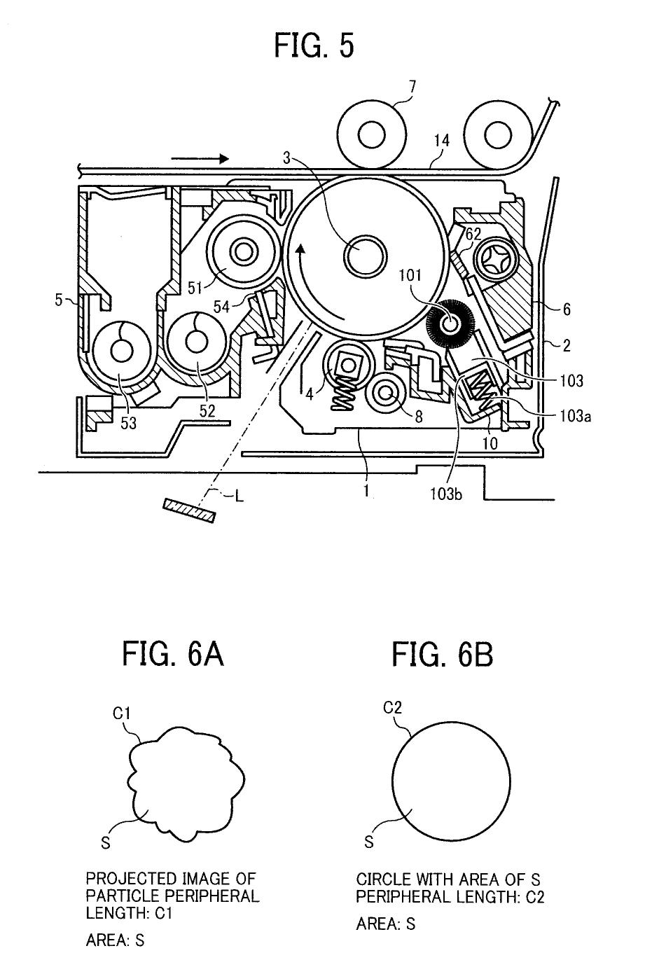

FIG. 5 illustrates one of the four image forming units 1.

As illustrated in FIG. 5, the image forming unit 1 includes a drum-shaped photoreceptor 3 serving as a photoreceptor. The shape of the photoreceptor 3 is not limited thereto, and sheet-shaped photoreceptors, endless belt-shaped photoreceptors and the like can also be used.

Around the photoreceptor 3, a charging roller 4, an image developer 5, a primary transfer roller 7, a cleaner 6, a lubricant applicator 10, a discharging lamp (not shown), etc., are arranged. The charging roller 4 serves as a charger for charging a surface of the photoreceptor 3. The image developer 5 serves as an image developer for developing an electrostatic latent image formed on the photoreceptor 3 with a developer to form a toner image thereon. The primary transfer roller 7 serves as a primary transferer for transferring the toner image on the photoreceptor 3 to the intermediate transfer belt 14. The cleaner 6 serves as a cleaner for removing residual toner from the surface of the photoreceptor 3 after transferring the toner image. The lubricant applicator 10 serves as a lubricant applicator for applying a lubricant to the surface of the photoreceptor 3 after cleaning the surface. The discharging lamp (not shown) serves as a discharger for decaying residual charges remaining on the surface of the photoreceptor 3 after cleaning the surface.

The charging roller 4 is arranged in the vicinity of the photoreceptor 3 with a predetermined gap therebetween, and evenly charges the photoreceptor 3 so that the photoreceptor 3 has a predetermined potential with a predetermined polarity. The thus evenly charged surface of the photoreceptor 3 is irradiated with the light beam L emitted by the optical writing unit 40 based on image information, thereby forming an electrostatic latent image on the surface of the photoreceptor 3.

The image developer 5 has a developing roller 51 serving as a developer bearing member. A development bias is applied to the developing roller 51 by a power source (not shown). A supplying screw 52 and an agitating screw 53 are provided in a casing of the image developer 5 to feed the developer in opposite directions in the casing so that the developer is charged so as to have a charge with a predetermined polarity. In addition, a doctor 54 is provided in the image developer to form a developer layer having a predetermined thickness on the surface of the developing roller 51. The layer of the developer, which has been charged so as to have a charge with the predetermined polarity, is adhered to an electrostatic latent image on the photoreceptor 3 at a development region, in which the developing roller 51 is opposed to the photoreceptor 3, resulting in formation of a toner image on the surface of the photoreceptor 3.

The cleaner 6 includes a fur brush 101, the cleaning blade 62, etc. The cleaning blade 62 is contacted with the surface of the photoreceptor 3 in such a manner as to counter the rotated photoreceptor 3. The cleaning blade 62 has the above-mentioned elastic blade.

The lubricant applicator 10 includes a solid lubricant 103, and a pressing spring 103a to press the solid lubricant 103 toward the fur brush 101 serving as a lubricant applicator to apply the lubricant to the surface of the photoreceptor 3. The solid lubricant 103 is supported by a bracket 103b while being pressed toward the fur brush 101 by the pressing spring 103a. The solid lubricant 103 is scraped by the fur brush 101, which is driven by the photoreceptor 3 so as to rotate (counterclockwise in FIG. 5), thereby applying the lubricant 103 to the surface of the photoreceptor 3. By thus applying the lubricant, the friction coefficient of the surface of the photoreceptor 3 can be controlled so as to be not higher than 0.2.

Although the non-contact short-range charging roller 4 is used as the charger of the image forming unit 1, the charger is not limited thereto, and contact chargers (such as contact charging rollers), corotrons, scorotrons, solid state chargers, and the like can also be used for the charger. Among these chargers, contact chargers, and non-contact short-range chargers are preferable because of having advantages such that the charging efficiency is high, the amount of ozone generated in a charging operation is small, and the charger can be miniaturized.

Specific examples of light sources for use in the optical writing unit 40 and the discharging lamp include any known light emitters such as fluorescent lamps, tungsten lamps, halogen lamps, mercury lamps, sodium lamps, light emitting diodes (LEDs), laser diodes (LDs), electroluminescent lamps (ELs), and the like.

In order to irradiate the photoreceptor 3 with light having a wavelength in a desired range, sharp cut filters, bandpass filters, infrared cut filers, dichroic filters, interference filters, color temperature converting filters, and the like can be used.

Among these light sources, LEDs and LDs are preferably used because of having advantages such that the irradiation energy is high, and light having a relatively long wavelength of from 600 to 800 nm can be emitted.

The transfer unit 60 serving as a transferer includes not only the intermediate transfer belt 14, but also a belt cleaning unit 162, a first bracket 63, and a second bracket 64. In addition, the transfer units 60 further includes four primary transfer rollers 7Y, 7C, 7M and 7K, a secondary transfer backup roller 66, a driving roller 67, a supplementary roller 68, and a tension roller 69. The intermediate transfer belt 14 is rotated counterclockwise in an endless manner by the driving roller 67 while being tightly stretched by the four rollers. The four primary transfer rollers 7Y, 7C, 7M and 7K press the thus rotated intermediate transfer belt 14 toward the photoreceptors 3Y, 3C, 3M and 3K, respectively, to form four primary transfer nips. In addition, a transfer bias having a polarity opposite that of the charge of the toner is applied to the backside (i.e., inner surface) of the intermediate transfer belt (for example, a positive bias is applied when a negative toner is used). Since the intermediate transfer belt 14 is rotated endlessly, yellow, cyan, magenta and black toner images, which are formed on the photoreceptors 3Y, 3C, 3M and 3K, respectively, are sequentially transferred onto the intermediate transfer belt 14 so as to be overlaid, resulting in formation of a combined color toner image on the intermediate transfer belt 14.

The secondary transfer backup roller 66 and a secondary transfer roller 70 sandwich the intermediate transfer belt 14 to form a secondary transfer nip. As mentioned above, the pair of registration rollers 55 pinches the transfer paper sheet P once, and then timely feeds the paper sheet P toward the secondary transfer nip so that the combined color toner image on the intermediate transfer belt 14 is transferred onto a predetermined position of the paper sheet P. Specifically, the entire combined color toner image is transferred due to a secondary transfer electric field formed by the secondary transfer roller 70, to which a secondary transfer bias is applied, and the secondary transfer backup roller 66, and a nip pressure applied between the secondary transfer roller 70 and the transfer backup roller 66, resulting in formation of a full color toner image on the paper sheet P having white color.

After passing the secondary transfer nip, the intermediate transfer belt 14 bears residual toners (i.e., non-transferred toners) on the surface thereof. The belt cleaning unit 162 removes the residual toners from the surface of the intermediate transfer belt 14. Specifically, a belt cleaning blade 162a of the belt cleaning unit 162 is contacted with the surface of the intermediate transfer belt 14 to remove the residual toners therefrom.

The first bracket 63 of the transfer unit 60 is rotated at a predetermined rotation angle on a rotation axis of the supplementary roller 68 by being driven by an on/off operation of a solenoid (not shown). When a monochromatic image is formed, the printer 500 slightly rotates the first bracket 63 counterclockwise by driving the solenoid. When the first bracket 63 is thus rotated, the primary transfer rollers 7Y, 7C and 7M are moved counterclockwise around the rotation axis of the supplementary roller 68, thereby separating the intermediate transfer belt 14 from the photoreceptors 3Y, 3C and 3M. Thus, only the black image forming unit 1K is operated (without driving the color image forming units 1Y, 1C and 1M) to form a monochromatic image. By using this method, the life of the parts of the color image forming units 1Y, 1C and 1M can be prolonged.

As illustrated in FIG. 4, a fixing unit 80 is provided above the secondary transfer nip. The fixing unit 80 includes a pressure/heat roller 81 having a heat source (such as a halogen lamp) therein, and a fixing belt unit 82. The fixing belt unit 82 includes an endless fixing belt 84 serving as a fixing member, a heat roller 83 having a heat source (such as a halogen lamp) therein, a tension roller 85, a driving roller 86, a temperature sensor (not shown), and the like. The endless fixing belt 84 is counterclockwise rotated endlessly by the driving roller 86 while being tightly stretched by the heat roller 83, the tension roller 85 and the driving roller 86. When the fixing belt 84 is rotated, the fixing belt is heated by the heat roller 83 from the backside thereof. The pressure/heat roller 81 is contacted with the front surface of the fixing belt 84 while pressing the fixing belt 84 to the heat roller 83, resulting in formation of a fixing nip between the pressure/heat roller 81 and the fixing belt 84.

A temperature sensor (not shown) is provided so as to be opposed to the front surface of the fixing belt 84 with a predetermined gap therebetween to detect the temperature of the fixing belt 84 at a location just before the fixing nip. The detection data are sent to a fixing device supply circuit (not shown). The fixing device supply circuit performs ON/OFF control on the heat source in the heat roller 83 and the heat source in the pressure/heat roller 81.

The transfer paper sheet P passing the secondary transfer nip and separated from the intermediate transfer belt 14 is fed to the fixing unit 80. When the paper sheet P bearing the unfixed full color toner image thereon is fed from the lower side of the fixing unit 80 to the upper side thereof while being sandwiched by the fixing belt 14 and the pressure/heat roller 81, the paper sheet P is heated by the fixing belt 84 while being pressed by the pressure/heat roller 81, resulting in fixation of the full color toner image on the paper sheet P.

The paper sheet P thus subjected to a fixing treatment is discharged from the main body of the printer 500 by a pair of discharging rollers 87 so as to be stacked on a surface of a stacking portion 88.

Four toner cartridges 100Y, 100C, 100M and 100K respectively containing yellow, cyan, magenta and black color toners are provided above the transfer unit 60 to supply the yellow, cyan, magenta and black color toners to the corresponding image developers 5Y, 5C, 5M and 5K of the image forming units 1Y, 1C, 1M and 1K, if desired. These toner cartridges 100Y, 100C, 100M and 100K are detachable from the main body of the printer 500 independently of the image forming units 1Y, 1C, 1M and 1K.

Next, the image forming operation of the printer 500 is explained.

Upon receipt of a print execution signal from an operating portion (not shown) such as an operation panel, predetermined voltages or currents are applied to the charging roller 4 and the developing roller 51 at predetermined times. Similarly, predetermined voltages or currents are applied to the light sources of the optical writing unit 40 and the discharging lamp. In synchronization with these operations, the photoreceptors 3 are rotated in a direction indicated by an arrow by a driving motor (not shown).

When the photoreceptors 3 are rotated, the surfaces thereof are charged by the respective charging rollers 4 so as to have predetermined potentials. Next, light beams L (such as laser beams) emitted by the optical writing unit 40 irradiate the charged surfaces of the photoreceptors 3, thereby forming electrostatic latent images on the surface of the photoreceptors 3.

The surfaces of the photoreceptors 3 bearing the electrostatic latent images are rubbed by magnetic brushes of the respective developers formed on the respective developing rollers 51. In this case, the (negatively-charged) toners on the developing rollers 51 are moved toward the electrostatic latent images by the development biases applied to the developing rollers 51, resulting in formation of color toner images on the surface of the photoreceptors 3Y, 3C, 3M and 3K.

Thus, each of the electrostatic latent images formed on the photoreceptors 3 is subjected to a reverse development treatment using a negative toner. In this example, an N/P (negative/positive: a toner adheres to a place having lower potential) developing method using a non-contact charging roller is used, but the developing method is not limited thereto.

The color toner images formed on the surfaces of the photoreceptors 3Y, 3C, 3M and 3K are primarily transferred to the intermediate transfer belt 14 so as to be overlaid, thereby forming a combined color toner image on the intermediate transfer belt 14.

The combined color toner image thus formed on the intermediate transfer belt 14 is transferred onto a predetermined portion of the paper sheet P, which is fed from the first or second cassette 151 or 152 and which is timely fed to the secondary transfer nip by the pair of registration rollers 55 after being pinched thereby. After the paper sheet P bearing the combined color toner image thereon is separated from the intermediate transfer belt 14, the paper sheet P is fed to the fixing unit 80. When the paper sheet P bearing the combined color toner image thereon passes the fixing unit 80, the combined toner image is fixed to the paper sheet P upon application of heat and pressure thereto. The paper sheet P bearing the fixed combined color toner image (i.e., a full color image) thereon is discharged from the main body of the printer 500, resulting in stacking on the surface of the stacking portion 88.

Toners remaining on the surface of the intermediate transfer belt 14 even after the combined color toner image thereon is transferred to the paper sheet P are removed therefrom by the belt cleaning unit 162.

Toners remaining on the surfaces of the photoreceptors 3 even after the color toner images thereon is transferred to the intermediate transfer belt 14 are removed therefrom by the cleaner 6. Further, the surfaces of the photoreceptors 3 are coated with a lubricant by the lubricant applicator 10, followed by a discharging treatment using a discharging lamp.

As illustrated in FIG. 5, the photoreceptor 3, the charging roller 4, the developing device 5, the cleaner 6, the lubricant applicator 10, and the like are contained in a case 2 of the image forming unit 1 of the printer 500. The image forming unit 10 is detachable attachable to the main body of the printer 500 as a single unit (i.e., process cartridge). However, the image forming unit 1 is not limited thereto, and may have a configuration such that each of the members and devices such as the photoreceptor 3, charging roller 4, developing device 5, cleaner 6, and lubricant applicator 10 is replaced with a new member or device.

The present invention is an image forming apparatus using the image forming means. The image forming means may be fixedly installed in copiers, facsimiles and printers, and may detachably be installed in the form a process cartridge as explained below.

### <Process Cartridge>

The process cartridge of the present invention includes at least an electrophotographic photoreceptor, a cleaner contacting an edge line of its elastic blade to the surface of the electrophotographic photoreceptor and one of a charger, an irradiator, an image developer, a transferer and a discharger.

The process cartridge can detachably be installed in various image forming apparatuses, facsimiles and printers, and preferably installed in the image forming apparatus in particular.

FIG. 5 is a schematic view illustrating an embodiment of the process cartridge.

The process cartridge in FIG. 5 includes an electrophotographic photoreceptor (photoreceptor drum) 3, a charger 4, an irradiator L, an image developer 51, a transferer 14, a cleaning blade 62 as a cleaner, and other means when necessary.

The photoreceptor 3 is charged by the charger 4 and irradiated by the irradiator L while rotating to form an electrostatic latent image on its surface.

The electrostatic latent image is developed by the image developer 51 with a toner to form a toner image. The toner image is transferred by the transferer 14 to a recording medium, and printed out. Then, the surface of the photoreceptor is cleaned by the cleaning blade 62, and further discharged by discharger (not illustrated). These operations are repeated.

Next, the toner for use in the printer 500 (i.e., the image forming apparatus of the present invention) will be described.

The toner is preferably a toner having a high circularity and a small particle diameter. Such a toner can be preferably prepared by polymerization methods such as suspension polymerization methods, emulsion polymerization methods, dispersion polymerization methods, and the like. The toner preferably has an average circularity not less than 0.97, and a volume-average particle diameter not greater than 5.5 μm to produce high resolution toner images.

The average circularity of the toner is measured using a flow particle image analyzer FPIA-2000 from Sysmex Corp. The procedure is as follows:

(1) initially, 100 to 150 ml of water, from which solid foreign materials have been removed, 0.1 to 0.5 ml of a surfactant (e.g., alkylbenzenesulfonate) and 0.1 to 0.5 g of a sample (i.e., toner) are mixed to prepare a dispersion;
(2) the dispersion is further subjected to a supersonic dispersion treatment for 1 to 3 minutes using a supersonic dispersion machine to prepare a dispersion including particles at a concentration of from 3,000 to 10,000 pieces/μl;
(3) the dispersion set in the analyzer so as to be passed through a detection area formed on a plate in the analyzer; and
(4) the particles of the sample passing through the detection area are optically detected by a CCD camera and then the shapes of the toner particles and the distribution of the shapes are analyzed with an image analyzer to determine the average circularity of the sample.

The method for determining the circularity of a particle will be described by reference to FIGS. 4A and 4B. When the projected image of a particle has a peripheral length C1 and an area S as illustrated in FIG. 4A, and the peripheral length of the circle having the same area S is C2 as illustrated in FIG. 4B, the circularity of the particle is obtained by the following equation.

Circularity=C2/C1

The average circularity of the toner is obtained by averaging circularities of particles.

The volume-average particle diameter of toner can be measured, for example, by an instrument such as COULTER MULTISIZER 2e manufactured by Beckman Coulter Inc. Specifically, the number-based particle diameter distribution data and the volume-based particle diameter distribution data are sent to a personal computer via an interface manufactured by Nikkaki Bios Co., Ltd. to be analyzed. The procedure is as follows:
(1) a surfactant serving as a dispersant, preferably 0.1 to 5 ml of a 1% aqueous solution of an alkylbenzenesulfonic acid salt, is added to an electrolyte such as 1% aqueous solution of first class NaCl;
(2) 2 to 20 mg of a sample (toner) to be measured is added into the mixture;
(3) the mixture is subjected to an ultrasonic dispersion treatment for about 1 to 3 minutes; and
(4) the dispersion is added to 100 to 200 ml of an aqueous solution of an electrolyte in a beaker so that the mixture includes the particles at a predetermined concentration;
(5) the diluted dispersion is set in the instrument to measure particle diameters of 50,000 particles using an aperture of 100 μm to determine the volume average particle diameter.

In this regard, the following 13 channels are used:
(1) not less than 2.00 μm and less than 2.52 μm;
(2) not less than 2.52 μm and less than 3.17 μm;
(3) not less than 3.17 μm and less than 4.00 μm;
(4) not less than 4.00 μm and less than 5.04 μm;
(5) not less than 5.04 μm and less than 6.35 μm;
(6) not less than 6.35 μm and less than 8.00 μm;
(7) not less than 8.00 μm and less than 10.08 μm;
(8) not less than 10.08 μm and less than 12.70 μm;
(9) not less than 12.70 μm and less than 16.00 μm;
(10) not less than 16.00 μm and less than 20.20 μm;
(11) not less than 20.20 μm and less than 25.40 μm;
(12) not less than 25.40 μm and less than 32.00 μm; and
(13) not less than 32.00 μm and less than 40.30 μm.

Namely, particles having a particle diameter of from 2.00 to 40.30 μm are targeted.

In this regard, the volume average particle diameter is obtained by the following equation.

Volume average particle diameter=ΣXfV/ΣfV,

wherein X represent the representative particle diameter of each channel, V represents the volume of the particle having the representative particle diameter, and f represents the number of particles having particle diameters in the channel.

As a toner preferably used in the image forming apparatus of the present invention, a toner prepared by kneading and pulverizing methods of melting and kneading a resin, a colorant, a charge controlling agent and a release agent to prepare a kneaded mixture, cooling the mixture to be solidified, and pulverizing and classifying the mixture can be used. A toner prepared by polymerization methods such as emulsion polymerizations and solution suspension methods is more preferably used.

As an example, constituents of a polyester polymerization toner are specifically explained.

### —Polyester Resin—

The polyester resin is formed by a polycondensation reaction between a polyol and a polycarboxylic acid.

As the polyol (PO), diol (DIO) and polyol having 3 valences or more (TO) can be used, and DIO alone or a mixture of DIO and a small amount of TO is preferably used.

Specific examples of DIO include alkylene glycol such as ethylene glycol, 1,2-propylene glycol, 1,3-propylene glycol, 1,4-butanediol, and 1,6-hexanediol; alkylene ether glycol such as diethylene glycol, triethylene glycol, dipropylene glycol, polyethylene glycol, polypropylene glycol and polytetramethylene ether glycol; alicyclic diol such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide.

In particular, alkylene glycol having 2 to 12 carbon atoms and adducts of bisphenol with an alkylene oxide are preferably used, and a mixture thereof is more preferably used.

Specific examples of TO include multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide.

As the polycarboxylic acid (PC), dicarboxylic acid (DIC) and polycarboxylic acid having 3 or more valences (TC) can be used. DIC alone, or a mixture of DIC and a small amount of TC are preferably used.

Specific examples of DIC include alkylene dicarboxylic acids such as succinic acid, adipic acid and sebacic acid; alkenylene dicarboxylic acid such as maleic acid and fumaric acid; and aromatic dicarboxylic acids such as phthalic acid, isophthalic acid, terephthalic acid and naphthalene dicarboxylic acid. In particular, alkenylene dicarboxylic acid having 4 to 20 carbon atoms and aromatic dicarboxylic acid having 8 to 20 carbon atoms are preferably used.

Specific examples of TC include aromatic polycarboxylic acids having 9 to 20 carbon atoms such as trimellitic acid and pyromellitic acid.

PC can be formed from a reaction between the PO and the above-mentioned acids anhydride or lower alkyl ester such as methyl ester, ethyl ester and isopropyl ester.

PO and PC are mixed such that an equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

Polyol (PO) and polycarboxylic acid (PC) are heated at a temperature of from 150 to 280° C. in the presence of a known catalyst such as tetrabutoxy titanate and dibutyltinoxide. Then, water generated is removed, under a reduced pressure if desired, to prepare a polyester resin having a hydroxyl group.

The polyester resin preferably has a hydroxyl value not less than 5 mg KOH/g and an acid value of from 1 to 30 mg KOH/g, and more preferably from 5 to 20 mg KOH/g. Such a polyester resin tends to be negatively charged, and the resultant toner has good affinity with a paper and low temperature fixability thereof is improved. However, when the acid value is greater than 30 mg KOH/g, chargeability of the resultant toner deteriorates particularly due to an environmental variation.

The polyester resin preferably has a weight-average molecular weight of from 10,000 to 400,000, and more preferably from 20,000 to 200,000. When less than 10,000, the offset resistance of the resultant toner deteriorates. When greater than 400,000, the low temperature fixability thereof deteriorates.

Besides the above-mentioned unmodified polyester resin (PE) formed by the polycondensation reaction, a urea-modified polyester resin (UMPE) is preferably included in the toner. The urea-modified polyester (UMPE) is formed from a reaction between a polyester prepolymer having an isocyanate group (A) and amines (B) used as a crosslinker and/or an elongation agent. The polyester prepolymer (A) can be formed from a reaction between polyester having an active hydrogen atom formed by polycondensation between polyol (PO) and a polycarboxylic acid, and polyisocyanate (PIC).

Specific examples of the PIC include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α,α,α′,α′-tetramethylxylylenediisocyanate; isocyanurate; the above-mentioned polyisocyanate blocked with phenol derivatives, oxime and caprolactam; and their combinations.

The PIC is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low temperature fixability of the resultant toner deteriorates. When [NCO] has a molar ratio less than 1, a urea content in ester of the modified polyester decreases and hot offset resistance of the resultant toner deteriorates.

The content of the constitutional component of a polyisocyanate in the polyester prepolymer (A) having a polyisocyanate group at its end portion is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low temperature fixability of the toner also deteriorate. In contrast, when the content is greater than 40% by weight, low temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the urea-modified polyester decreases and hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophorone diamine); aliphatic diamines (e.g., ethylene diamine, tetramethylene diamine and hexamethylene diamine); etc. Specific examples of the polyamines (B2) having three or more amino groups include diethylene triamine, triethylene tetramine.

Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids (B5) include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine is mixed with a small amount of a polyamine (B2) are preferably used.

The mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than ½, molecular weight of the urea-modified polyester decreases, resulting in deterioration of hot offset resistance of the resultant toner.

The UMPE may include a urethane bonding as well as a urea bonding. The molar ratio (urea/urethane) of the urea bonding to the urethane bonding is from 100/0 to 10/90, preferably from 80/20 to 20/80 and more preferably from 60/40 to 30/70. When the content of the urea bonding is less than 10%, hot offset resistance of the resultant toner deteriorates.

The UMPE can be produced by a method such as a one-shot method. Polyol (PO) and polycarboxylic acid (PC) are heated at a temperature of from 150 to 280° C. in the presence of a known catalyst such as tetrabutoxy titanate and dibutyltinoxide. Then, water generated is removed, under a reduced pressure if desired, to prepare a polyester resin having a hydroxyl group. Next, polyisocyanate is reacted with the polyester resin having a hydroxyl group at from 40 to 140° C. to prepare a polyester prepolymer (A) having an isocyanate group. Further, amines (B) are reacted with the polyester prepolymer (A) at from 0 to 140° C. to prepare a urea-modified polyester.

When polyisocyanate, and A and B are reacted, a solvent can be used if desired. Suitable solvents include solvents which do not react with polyisocyanate (PIC). Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoaminde; ethers such as tetrahydrofuran.

The molecular weight of the urea-modified polyesters can optionally be controlled using a reaction terminator. Specific examples of the reaction terminator include monoamines such as diethyle amine, dibutyl amine, butyl amine and lauryl amine, and blocked amines, i.e., ketimine compounds prepared by blocking the monoamines mentioned above.

The weight-average molecular weight of the modified polyester of the UMPE is not less than 10,000, preferably from 20,000 to 10,000,000 and more preferably from 30,000 to 1,000,000. When the weight-average molecular weight is less than 10,000, hot offset resistance of the resultant toner deteriorates. The number-average molecular weight of the modified polyester of the UMPE is not particularly limited when the unmodified polyester resin (PE) is used in combination. Namely, the weight-average molecular weight of the UMPE resins has priority over the number-average molecular weight thereof.

However, when the UMPE is used alone, the number-average molecular weight is from 2,000 to 15,000, preferably from 2,000 to 10,000 and more preferably from 2,000 to 8,000. When the number-average molecular weight is greater than 20,000, the low temperature fixability of the resultant toner deteriorates, and in addition the glossiness of full color images deteriorates.

In the present invention, not only the modified polyester of the UMPE alone but also the PE can be included as a toner binder with the UMPE. A combination thereof improves low temperature fixability of the resultant toner and glossiness of color images produced thereby, and the combination is more preferably used than using the UMPE alone. The PE may include a polyester resin modified by a chemical bonding besides urea bonding.

It is preferable that the UMPE at least partially mixes with the PE to improve the low temperature fixability and hot offset resistance of the resultant toner. Therefore, the UMPE preferably has a structure similar to that of the PE.

A mixing ratio (UMPE/PE) between the UMPE and PE is from 5/95 to 80/20, preferably from 5/95 to 30/70, more preferably from 5/95 to 25/75, and even more preferably from 7/93 to 20/80. When the UMPE is less than 5%, the hot offset resistance deteriorates, and in addition, it is disadvantageous to have both high temperature preservability and low temperature fixability.

The binder resin including the UMPE and the PE preferably has a glass transition temperature (Tg) of from 45 to 65° C., and preferably from 45 to 60° C. When the glass transition temperature is less than 405 C, the heat resistance of the toner deteriorates. When higher than 65° C., the low temperature fixability deteriorates.

Since the UMPE is present at the surface of a toner, the toner has better heat-resistant preservability than known toners including a polyester resin as a binder resin even though the glass transition temperature is low.

### <<Colorant>>

Specific examples of the colorant for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The toner preferably includes the colorant in an amount of from 1 to 15% by weight, and more preferably from 3 to 10% by weight.

The colorant for use in the present invention can be used as a master batch pigment when combined with a resin.

Specific examples of the resin for use in the master batch pigment or for use in combination with master batch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

### <<Charge Controlling Agent>>

The toner of the present invention may optionally include a charge controlling agent. Specific examples of the charge controlling agent include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc.

Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. These can be used alone or in combination, and it is preferable they negatively charge a toner.

The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large charge quantity, and thereby the electrostatic force of a developing roller attracting the toner increases, resulting in deterioration of the fluidity of the toner and decrease of the image density of toner images.

### <<Release Agent>>

The toner of the present invention may optionally include a release agent. A wax having a low melting point of from 50 to 120° C. is effectively used as the release agent. When such a wax is included in the toner, the wax is dispersed in the binder resin and serves as a release agent at a location between a fixing roller and the toner particles. Thereby, hot offset resistance can be improved without applying an oil to the fixing roller used.

Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes.

In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

These charge controlling agent and release agent can be kneaded together with a master batch pigment and resin. In addition, the charge controlling agent and release agent can be added when such toner constituents are dissolved or dispersed in an organic solvent.

### <<External Additive>>

After the toner is prepared, an external additive is applied to the surface thereof to improve fluidity, chargeability and cleanability thereof.

At least one of the external additives is preferably particulate hydrophobic silica.

The particulate hydrophobic silica is subjected to a surface treatment to increase hydrophobicity thereof, and capable of preventing the toner from deteriorating fluidity and chargeability even in high humidity. Specific examples of the surface treatment agent include a silane coupling agent, a silylation agent, a silane coupling agent having a fluorinated alkyl group, silicone oil, modified silicone oil, etc.

The particulate hydrophobic silica preferably has a primary average particle diameter of from 10 to 200 nm. When less than 10 nm, the toner deteriorates in cleanability and produces abnormal stripe images occasionally. When greater than 200 nm, the toner deteriorates in fluidity and chargeability and produces images having background fouling occasionally.

The primary average particle diameter of the particulate hydrophobic silica is measured by measuring diameters of 50 particles from observed images using an electron microscope such as SEM and TEM, and averaging them.

The particulate hydrophobic silica preferably has a hydrophobization of from 50 to 90%, and more preferably from 60 to 80%. When less than 50%, charge leaks more at high temperature and high humidity, resulting in toner scattering. When greater than 90%, the toner is charged too much at low temperature and low humidity, resulting in occasional poor image density. Further, an excessive hydrophobizer occasionally deteriorates fluidity of the toner.

The hydrophobization is measured as follows.

Fifty (50) ml of water are placed in a 20 ml beaker, and 0.2 g of the particulate hydrophobic silica is further added therein. Methanol is dripped therein from a burette, the head of which is dipped in water while gently stirred with a magnet stirrer. The floating particulate hydrophobic silica begins to sink and ml of the dripping methanol when the silica completely sinks is read, and the hydrophobization is determined by the following formula.

Hydrophobization (%)=(ml dripping methanol/(50+ml dripping methanol))×100

In addition to the hydrophobic silica, other external additives can be used and specific examples of inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

The content ratio of such inorganic particulates is preferably from 0.01 to 5% by weight and particularly preferably from 0.01 to 2% by weight based on the weight of toner.

### <<Other Components>>

The other components included in the toner include, but are not limited to, a fluidity improver, a cleanability improver, a magnetic material, a metal soap, etc.

A small size and nearly spherical toner is now used to produce high-quality images. The toner is difficult to clean, and an external additive such as the particulate hydrophobic silica is applied to the surface thereof to improve its cleanability and decrease its adherence with a photoreceptor and an intermediate transfer belt. Further, adherence between the toners is decreased to improve fluidity and chargeability thereof.

However, once the external additive such as the particulate hydrophobic silica is released from a toner, it is likely to adhere to the surface of a photoreceptor. The external additive adhering thereto gradually accumulates or a toner resin adheres to the external additive, resulting in increase of the adherent. Therefore, abnormal images including the adherent are likely to be produced. Particularly, the cleaning blade having a surface layer strongly pressing an external additive to a photoreceptor, and therefore it is likely to adhere thereto.

In the present invention, an electrophotographic photoreceptor having a specific surface form and a cleaning blade having an elastic blade having a specific layer composition are combined to have high durability of the photoreceptor and the cleaning blade. Further, particulate silica is prevented to adhere on the photoreceptor to produce high-definition and high-quality images for long periods.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### [Photoreceptor 1]

An undercoat coating liquid, a charge generation coating liquid and charge transport coating liquid, which have the following compositions, were dip-coated and dried in this order on an aluminum cylinder having a diameter of 40 mm to form an undercoat layer, a charge generation layer and a charge transport layer having thickness of 3.5 μm, 0.2 μm and 20 μm, respectively thereon. The layers were dried to touch and further dried at 130° C., 130° C. and 120° C. for 20 min, respectively to prepare an electrophotographic photoreceptor formed of an electroconductive substrate/an undercoat layer/a charge generation layer/and a charge transport layer.

(Undercoat Layer Coating Liquid)

| Titanium oxide | 50 |
|---|---|
| (CR-EL having a primary particle diameter of 0.25 μm and | |
| a particle density of 4.3 g/cm³ from Ishihara Sangyo Kaisha Ltd.) | |
| Alkyd resin | 14 |
| (BECKOLITE M6401-50 having a solid content of 50% from | |
| Dainippon Ink And Chemicals, Inc.) | |
| Melamine resin | 8 |
| (L-145-60 having a solid content of 60% from Dainippon Ink | |
| And Chemicals, Inc.) | |
| 2-butanone | 70 |

(Charge Generation Layer Coating Liquid)

| | |
|---|---|
| Bisazo pigment having the following formula | 5 |

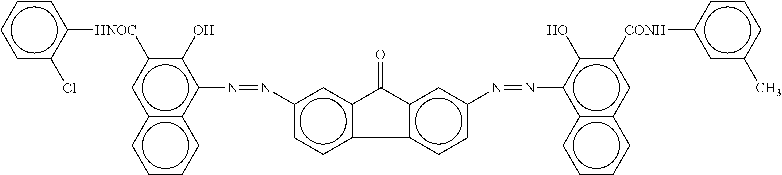

| | |
|---|---|
| Polyvinylbutyral (XYHL from Union Carbide Corp.) | 1 |
| Cyclohexanone | 300 |

(Charge Transport Layer Coating Liquid)

| | |
|---|---|
| Z-type polycarbonate | 10 |
| (Panlite TS-2050 from TEIJIN CHEMICALS LTD.) | |
| Charge transport material | 7 |
| having the following formula | |

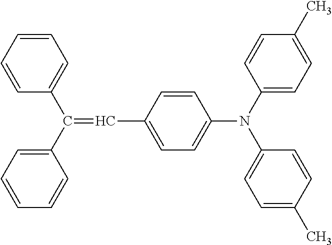 [SMILES: Cc1ccc(N(c2ccc(C)cc2)c2ccc(C=C(c3ccccc3)c3ccccc3)cc2)cc1]

| | |
|---|---|
| Tetrahydrofuran | 68 |
| 1% silicone oil solution in tetrahydrofuran | 0.2 |
| (KF50-1CS from Shin-Etsu Chemical Industry Co., Ltd.) | |

### [Photoreceptor 2]

A protection layer coating liquid having the following composition was spray-coated on the photoreceptor 1 and irradiated with a UV lamp having a H bulb from Fusion UV Systems, Inc. at 200 W/cm and 450 mW/cm² for 30 sec to be crosslinked. Then, the crosslinked layer was dried at 130° C. for 20 min to prepare an electrophotographic photoreceptor formed of an electroconductive substrate/an undercoat layer/a charge generation layer/a charge transport layer/and a protection layer. The protection layer had a thickness of about 2 μm.

(Protection Layer Coating Liquid)

| | |
|---|---|
| TMPTA | 10 |

(Trimethylolpropanetriacrylate KAYARAD TMPTA from
Nippon Kayaku Co., Ltd., having a molecular weight of 296, 3 functional
groups, a functional group equivalent molecular weight of 99 and resin
density of 1.1 g/cm³)

| | |
|---|---|
| Charge transport material | 10 |
| having the following formula | |

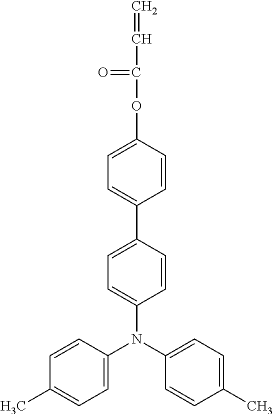

| | |
|---|---|
| Photopolymerization initiator | 0.5 |

1-hydroxy-cyclohexyl-phenyl-ketone (Irgacure 184,
from Ciba Specialty Chemicals)

| | |
|---|---|
| Tetrahydrofuran | 180 |

### [Photoreceptor 3]

The procedure for preparation of the photoreceptor 2 was repeated except for replacing the protection layer coating liquid with the following one.

(Protection Layer Coating Liquid)

| | |
|---|---|
| TMPTA | 10 |

(Trimethylolpropanetriacrylate KAYARAD TMPTA from Nippon
Kayaku Co., Ltd., having a molecular weight of 296, 3 functional
groups, a functional group equivalent molecular weight of 99
and a resin density of 1.1 g/cm³)

| | |
|---|---|
| Silicone (particulate non-metal oxide) | 0.8 |

(Tospearl 103 from Momentive Performance Materials, Inc. having
a primary particle diameter of 300 nm and a particle density of
1.3 g/cm³)

| | |
|---|---|
| Photopolymerization initiator | 0.5 |

1-hydroxy-cyclohexyl-phenyl-ketone (Irgacure 184, from Ciba
Specialty Chemicals)

| | |
|---|---|
| Tetrahydrofuran | 180 |

### [Photoreceptors 4 to 16 and 18 to 25]

The procedure for preparation of the photoreceptor 3 was repeated except for replacing the resin and the filler in the protection layer coating liquid with materials in Table 1. The protection layer had a thickness of about 2 μm. The photopolymerization initiator was added by 5% by weight per 100% by weight of the resin in each of the protection layer coating liquids. The protection layer coating liquid was diluted in tetrahydrofuran to have a solid content concentration about 10%.

### [Photoreceptor 17]

A protection layer coating liquid having the following composition was spray-coated on the photoreceptor 1. Then, the layer was dried at 130° C. for 20 min to prepare an electrophotographic photoreceptor formed of an electroconductive substrate/an undercoat layer/a charge generation layer/a charge transport layer/and a protection layer. The protection layer had a thickness of about 2 μm.

(Protection Layer Coating Liquid)

| Phenol resin | 14.3 |
|---|---|
| (PR-51206 from Sumitomo Bakelite Co., Ltd., having a solid | |
| content concentration of 70% and a resin density of 1.4 g/cm³) | |
| Zinc oxide | 4 |
| (NanoTek Powder ZnO having a primary particle diameter of | |
| 34 nm, a resin density of 5.8 g/cm³ from CIK NanoTek Co., Ltd.) | |
| Tetrahydrofuran | 126 |

Materials in Table 1 are as follows.

### <<Protection Layer Resin>>

TMPTA

(Trimethylolpropanetriacrylate KAYARAD TMPTA from Nippon Kayaku Co., Ltd., having a molecular weight of 296, 3 functional groups, a functional group equivalent molecular weight of 99 and a resin density of 1.1 g/cm³)

SR355

(ditrimethylolpropanetetraacrylate from Sartomer Company Inc.)

DPCA-30

(Modified dipentaerythritolhexaacrylate from Nippon Kayaku Co., Ltd., having a molecular weight of 921, 6 functional groups, a functional group equivalent molecular weight of 154 and a resin density of 1.1 g/cm³)

PETTA

(Pentaerythritoltetraacrylate M-450 from TOAGOSEI CO., LTD., having a molecular weight of 352, 4 functional groups, a functional group equivalent molecular weight of 88 and a resin density of 1.1 g/cm³)

Phenol Resin

(PR-51206 from Sumitomo Bakelite Co., Ltd., having a solid content concentration of 70% and a resin density of 1.4 g/cm³)

### <<Filler>>

Titanium Oxide 1

(CR-EL having a primary particle diameter of 0.25 μm and a particle density of 4.3 g/cm³ from Ishihara Sangyo Kaisha Ltd.)

Titanium Oxide 2

(NanoTek Powder TiO₂ having a primary particle diameter of 36 nm and a resin density of 3.7 g/cm³ from CIK NanoTek Co., Ltd.)

Titanium Oxide 3

(PT-501A having a primary particle diameter of 100 nm and a resin density of 3.9 m³ from Ishihara Sangyo Kaisha Ltd.)

Silica

(SNOWTEX OXS having a primary particle diameter of from 4 to 6 nm, a resin density of 2.2 g/cm³ and a solid content concentration of 10% from NISSAN CHEMICAL INDUSTRIES, LTD.)

Alumina

(ALUMINASOL having a primary particle diameter of from 10 to 20 nm, a resin density of 3.5 g/cm³ and a solid content concentration of 20% from NISSAN CHEMICAL INDUSTRIES, LTD.)

Zinc Oxide

(NanoTek Powder ZnO having a primary particle diameter of 34 nm, a resin density of 5.8 g/cm³ from CIK NanoTek Co., Ltd.)

Silicone

(Tospearl 103 from Momentive Performance Materials, Inc. having a primary particle diameter of 300 nm and a particle density of 1.3 g/cm³)<

<Filler Volume Content Rate>

Platinum palladium was coated on a chip of a photoreceptor to impart conductivity thereto, and platinum carbon was coated thereon to protect the surface thereof to prepare an observation sample. A cross-section of the sample was modified using a converging ion beam (FIB) and observed with a thermal FE-SEM at 10,000-fold magnifications. Quanta 2000 3D from FEI Company Japan Ltd. was used as an FIB apparatus and ULTRA55 from Carl Zeiss was used as a thermal FE-SEM.

A part of the SEM image where the filler is present and a part thereof where the filler is not present were digitalized using image analysis software LMeye from Lasertec Corp. An areal ratio of the digitalized parts was calculated by the same software and S1/(S1+S2) in which S1 is an area where the filler is present and S2 is an area where the filler is not present was determined. An average of 10 SEM images was a filler volume content rate.

### <<Ten-Point Surface Roughness Rz and an Average Interval Between Concavities and Convexities Sm>>

Based on JIS B 0601:2001, ten-point surface roughness Rz and an average interval between concavities and convexities Sm were measured using SURFCOM 1400D from TOKYO SEIMITSU CO., LTD. under the following conditions.

Length: 2.5 mm

Cutoff wavelength: 0.8 mm

Speed: 0.06 mm/sec

Pickup: 5 μm pick up

TABLE 1

| Photo- | Rz | Sm | Protection | Protection | | Filler volume | Filler particle |
|---|---|---|---|---|---|---|---|
| receptor | (μm) | (μm) | layer | layer resin | Filler | content rate (%) | diameter (nm) |
| 1 | 0.6 | 110 | None | — | — | — | — |
| 2 | 0.8 | 150 | Yes | TMPTA | — | — | — |
| 3 | 0.9 | 130 | Yes | TMPTA | Silicone | 8 | 300 |
| 4 | 0.8 | 150 | Yes | TMPTA | Titanium | 8 | 250 |
| | | | | | oxide 1 | | |
| 5 | 0.9 | 200 | Yes | TMPTA | Titanium | 5 | 250 |
| | | | | | oxide 1 | | |
| 6 | 2.1 | 75 | Yes | TMPTA | Titanium | 42 | 250 |
| | | | | | oxide 1 | | |
| 7 | 1.0 | 150 | Yes | TMPTA | Titanium | 11 | 250 |
| | | | | | oxide 1 | | |
| 8 | 2.2 | 40 | Yes | TMPTA | Titanium | 38 | 250 |
| | | | | | oxide 1 | | |
| 9 | 1.7 | 280 | Yes | TMPTA | Alumina | 25 | 5 |
| 10 | 1.6 | 250 | Yes | TMPTA | Titanium | 25 | 250 |
| | | | | | oxide 1 | | |
| 11 | 0.9 | 145 | Yes | TMPTA | Silica | 25 | 10-20 |
| 12 | 1.3 | 135 | Yes | TMPTA | Titanium | 25 | 100 |
| | | | | | oxide 3 | | |
| 13 | 1.5 | 70 | Yes | SR355 | Zinc | 25 | 34 |
| | | | | | oxide | | |
| 14 | 1.6 | 50 | Yes | DPCA-30 | Titanium | 25 | 36 |
| | | | | | oxide 2 | | |
| 15 | 1.3 | 65 | Yes | PETTA | Zinc | 25 | 31 |
| | | | | | oxide | | |
| 16 | 1.6 | 50 | Yes | TMPTA | Zinc | 25 | 34 |
| | | | | | oxide | | |
| 17 | 1.4 | 130 | Yes | PR-51206 | Zinc | 15 | 34 |
| | | | | | oxide | | |
| 18 | 0.5 | 270 | Yes | TMPTA | Zinc | 15 | 34 |
| | | | | | oxide | | |
| 19 | 2.3 | 65 | Yes | TMPTA | Zinc | 35 | 34 |
| | | | | | oxide | | |
| 20 | 1.7 | 35 | Yes | TMPTA | Zinc | 40 | 34 |
| | | | | | oxide | | |
| 21 | 0.9 | 290 | Yes | TMPTA | Zinc | 10 | 34 |
| | | | | | oxide | | |
| 22 | 0.3 | 100 | Yes | TMPTA | Zinc | 7 | 34 |
| | | | | | oxide | | |
| 23 | 2.6 | 50 | Yes | TMPTA | Zinc | 45 | 34 |
| | | | | | oxide | | |
| 24 | 2.4 | 25 | Yes | TMPTA | Zinc | 50 | 34 |
| | | | | | oxide | | |
| 25 | 0.9 | 310 | Yes | TMPTA | Zinc | 5 | 34 |
| | | | | | oxide | | |

Next, the cleaning blade of the present invention is explained.

### Blade Preparation Example

### [Substrate Elastic Blade]

The following materials were used for the elastic blade 622.

| | | Resilience | |
|---|---|---|---|
| | Hardness (°) at | coefficient (%)at | |
| Material | 25° C. | 25° C. | Manufacturer |
| Urethane rubber 1 | 66 | 46 | Bando Chemical |
| | | | Industries, Ltd. |
| Urethane rubber 2 | 70 | 50 | Toyo Tire & |
| | | | Rubber Co., Ltd. |
| Urethane rubber 3 | 72 | 31 | Toyo Tire & |
| | | | Rubber Co., Ltd. |
| Urethane rubber 4 | 75 | 21 | Toyo Tire & |
| | | | Rubber Co., Ltd. |
| Urethane rubber 5 | 77 | 19 | Synztec Co., Ltd. |

The hardness of the urethane rubbers 1-5 was measured by a method defined in HS K6253 using a durometer manufactured by Shimadzu Corp. When measuring the hardness, sheets (with a thickness of about 2 mm) of each of the urethane rubbers were overlaid so that the rubber has a thickness of not less than 12 mm.

The resilience coefficient of the urethane rubbers 1-5 was measured by a method defined in JIS K6255 using a resilience tester No. 221 manufactured by Toyo Seiki Seisaku-Sho Ltd. When measuring the resilience coefficient, sheets (with a thickness of about 2 mm) of each of the urethane rubbers were overlaid so that the rubber has a thickness of not less than 4 mm.

A reed-shaped elastic blade 622 having a thickness of 1.8 mm was formed from the urethane rubber. The elastic blade was subjected to the following processes to form a substrate and an acrylic and/or a methacrylic resin mixed layer 62d and an acrylic and/or a methacrylic resin surface layer 623.

### (Mixed Layer Forming Material)

The elastic blade 622 was dipped in the following mixed layer forming material liquid for a predetermined time to form a substrate and an acrylic and/or a methacrylic resin mixed layer 62d. The layer is crosslinked with a heat energy and an optical energy after an acrylic and/or a methacrylic resin surface layer is formed.

<Blade Mixed Layer Material 1>

| | |
|---|---|
| Monomer: Pentaerythritoltriacrylate | 10 |
| (PETIA from DAICEL-CYTEC Co., Ltd.) | |
| Polymerization initiator: IRGACURE 184 from | 1 |
| Ciba Specialty Chemicals | |
| Solvent: Tetrahydrofuran | 149 |

<Mixed Layer Material 2>

| | |
|---|---|
| Monomer: Pentaerythritoltriacrylate | 9 |
| (PETIA from DAICEL-CYTEC Co., Ltd.) | |
| Monomer 2: 1,6-hexanedioldiacryalate | 1 |
| (HDDA from DAICEL-CYTEC Co., Ltd.) | |
| Polymerization initiator: IRGACURE 184 | 1 |
| from Ciba Specialty Chemicals | |
| Solvent: Tetrahydrofuran | 149 |

<Mixed Layer Material 3>

| | |
|---|---|
| Monomer: Dipentaerythritolhexaacrylate | 10 |
| (DPHA from DAICEL-CYTEC Co., Ltd.) | |
| Polymerization initiator: IRGACURE 184 | 1 |
| from Ciba Specialty Chemicals | |
| Solvent: Tetrahydrofuran | 149 |

<Mixed Layer Material 4>

| | |
|---|---|
| Monomer: Caprolactone-modified dipentaerythritolhexaacrylate | 10 |
| (DPCA-120 from Nippon Kayaku Co., Ltd.) | |
| Polymerization initiator: IRGACURE 184 from Ciba | 1 |
| Specialty Chemicals | |
| Solvent: Tetrahydrofuran | 149 |

<Mixed Layer Material 5>

| | |
|---|---|
| Monomer 1: Hexamethylenediisocyanate | 8 |
| (SUMIJULE HT <HDI adduct> | |
| from Sumika Bayer Urethane Co., Ltd.) | |
| Monomer 2: Polyol having the following formula | 2 |
| (from KANTO CHEMICAL CO., INC.) | |
| 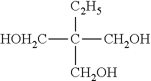 | |
| Solvent: Tetrahydrofuran | 110 |

### (Blade Surface Layer Forming Material)

The following surface layer forming material liquid was sprayed on the substrate and acrylic and/or a methacrylic resin mixed layer 62d to form an acrylic and/or a methacrylic resin surface layer 623 thereon. The surface layer forming materials 1 to 4 were irradiated with UV light to be optically crosslinked. The surface layer forming material 5 was heated to be thermally crosslinked. The surface layer thickness was controlled by the spray coating conditions such as a spray amount and a coating speed.

<Surface Layer Material 1>

| | |
|---|---|
| Monomer: PETIA from DAICEL-CYTEC Co., Ltd. | 10 |
| Polymerization initiator IRGACURE 184 from Ciba | 1 |
| Specialty Chemicals | |
| Solvent: 2-butanone | 89 |

<Surface Layer Material 2>

| | |
|---|---|
| Monomer 1: PETIA from DAICEL-CYTEC Co., Ltd. | 9 |
| Monomer 2: HDDA from DAICEL-CYTEC Co., Ltd. | 1 |
| Polymerization initiator IRGACURE 184 from Ciba | 1 |
| Specialty Chemicals | |
| Solvent: 2-butanone | 89 |

<Surface Layer Material 3>

| | |
|---|---|
| Monomer: DPHA from DAICEL-CYTEC Co., Ltd. | 10 |
| Polymerization initiator IRGACURE 184 from Ciba | 1 |
| Specialty Chemicals | |
| Solvent: 2-butanone | 89 |

<Surface Layer Material 4>

| | |
|---|---|
| Monomer: DPCA-120 (from Nippon Kayaku Co., Ltd.) | 10 |
| Polymerization initiator (IRGACURE 184 from | 1 |
| Ciba Specialty Chemicals) | |
| Solvent: 2-butanone | 89 |

<Surface Layer Material 5>

| | |
|---|---|
| Monomer 1: SUMIJULE HT <HDI adduct> | 8 |
| (from Sumika Bayer Urethane Co., Ltd.) | |
| Monomer 2: Polyol having the following formula | 2 |
| (from KANTO CHEMICAL CO., INC.) | |
| 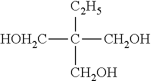 | |
| Solvent: 2-butanone | 70 |

### <Optical Crosslink Conditions>

UV irradiation: Metal Halide Lamp (from USHIO INC.)

Irradiation intensity: 500 mW/cm² (365 nm)

UV lamp-blade distance: 100 mm

Irradiation time: 60 sec

### <Thermal Crosslink Conditions>

Heating temperature: 150° C.

Heating time: 20 min

The thus prepared cleaning blades 1 to 19 are shown in Table 2.

TABLE 2

| | | Mixed Layer | | | Surface Layer | |
|---|---|---|---|---|---|---|
| | Base | | | Thickness | | Thickness |
| Blade | Blade | Material | Time (s) | (nm) | Material | (μm) |
| Blade 1 | 1 | 1 | 6 | 7 | 1 | 0.2 |
| Blade 2 | 4 | 1 | 6 | 7 | 1 | 0.4 |
| Blade 3 | 4 | 1 | 6 | 7 | 1 | 1.2 |
| Blade 4 | 4 | 1 | 6 | 7 | 1 | 0.5 |
| Blade 5 | 4 | 1 | 6 | 7 | 1 | 0.9 |
| Blade 6 | 5 | 1 | 9 | 8 | 1 | 0.7 |
| Blade 7 | 5 | 1 | 70 | 33 | 1 | 0.8 |
| Blade 8 | 5 | 1 | 12 | 11 | 1 | 0.7 |
| Blade 9 | 5 | 1 | 55 | 28 | 1 | 0.7 |
| Blade 10 | 1 | 2 | 37 | 20 | 2 | 0.8 |
| Blade 11 | 1 | 3 | 30 | 17 | 3 | 0.8 |
| Blade 12 | 1 | 4 | 25 | 15 | 4 | 0.8 |
| Blade 13 | 2 | 2 | 40 | 21 | 3 | 0.8 |
| Blade 14 | 3 | 3 | 44 | 23 | 2 | 0.8 |
| Blade 15 | 1 | — | — | — | — | — |
| Blade 16 | 1 | — | — | — | 1 | 0.8 |
| Blade 17 | 1 | 1 | 30 | 19 | — | — |
| Blade 18 | 1 | 5 | 7 | 9 | 1 | 0.6 |
| Blade 19 | 1 | 1 | 6 | 9 | 5 | 0.6 |

### Examples 1 to 35 and Comparative Examples 1 to 9

The elastic blade a surface layer is formed on was fixed with an adhesive on a metallic plate holder installable in color complex machine imagio MP C4500 from Ricoh Company, Ltd. as a trial cleaning blade. The cleaning blade was installed in color complex machine imagio MP C4500 from Ricoh Company, Ltd. at a linear pressure of 20 g/cm and a cleaning angle of 79°. Combinations of the electrophotographic photoreceptors and the blades are shown in Table 3.

A toner prepared by a polymerization method was used.

A mother toner had a circularity of 0.98 and an average particle diameter of 4.9 μm.

### Toner Preparation Example 1

### (Preparation of Mother Toner)

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were polycondensed in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare an unmodified polyester resin.

The unmodified polyester resin had a number-average molecular weight of 2,500, a weight-average molecular weight of 6,700, a Tg of 43° C. and an acid value of 25 mg KOH/g.

One thousand and two hundred (1,200) parts of water, 540 parts of carbon black Printex 35 from Degussa A.G. having a DBP oil absorption of 42 ml/100 mg and a pH of 9.5, 1,200 parts of the unmodified polyester resin were mixed by a Henschel Mixer from Mitsui Mining Co., Ltd. After the mixture was kneaded by a two-roll mill having a surface temperature of 150° C. for 30 min, the mixture was extended by applying pressure, cooled and pulverized by a pulverizer from Hosokawa Micron Limited to prepare a masterbatch.

378 parts of the unmodified polyester resin, 110 parts of carnauba wax, 22 parts of salicylic acid metal complex E-84 from Orient Chemical Industries Co., Ltd. and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the masterbatch and 500 parts of ethyl acetate were added to the mixture and mixed for 1 hr to prepare a material solution.

One thousand, three hundred and twenty four (1,324) parts of the material solution were transferred into another vessel, and the carbon black and carnauba wax therein were dispersed by a beads mill (Ultra Visco Mill from IMECS CO., LTD.) for 3 passes at a liquid feeding speed of 1 kg/hr and a peripheral disc speed of 6 msec using zirconia beads having diameter of 0.5 mm for 80% by volume to prepare a wax dispersion.

Next, 1,324 parts of an ethyl acetate solution of the unmodified polyester resin having a concentration of 65% were added to the wax dispersion. Three (3) parts of Claytone APA from Southern Clay Products, Inc. were added as a charge controlling agent to 200 parts of the wax dispersion subjected to one pass using the Ultra Visco Mill under the same conditions to prepare a mixture. The mixture was stirred at 7,000 rpm for 30 min with T. K. Homodisper from Tokushu Kika Kogyo Co., Ltd. to prepare a toner constituents dispersion.

Six hundred and eighty two (682) parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs to prepare an intermediate polyester resin.

The intermediate polyester resin had a number-average molecular weight of 2,100, a weight-average molecular weight of 9,500, a Tg of 55° C. and an acid value of 0.5 mg KOH/g and a hydroxyl value of 51 mg KOH/g.

Next, 410 parts of the intermediate polyester resin, 89 parts of isophoronediisocyanate and 500 parts of ethyl acetate were reacted in a reactor vessel including a cooling pipe, a stirrer and a nitrogen inlet pipe for 5 hrs at 100° C. to prepare a prepolymer. The prepolymer included a free isocyanate in an amount of 1.53% by weight.

One hundred and seventy (170) parts of isophoronediamine and 75 parts of methyl ethyl ketone were reacted at 50° C. for 5 hrs in a reaction vessel including a stirrer and a thermometer to prepare a ketimine compound. The ketimine compound had an amine value of 418 mg KOH/g.

Seven hundred and forty nine (749) parts of the toner constituents dispersion 1, 115 parts of the prepolymer and 2.5 parts of the ketimine compound were mixed in a vessel by a T. K. Homomixer from Tokushu Kika Kogyo Co., Ltd. at 5,000 rpm for 1 min to prepare an oil phase mixed liquid.

Six hundred and eighty three (683) parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted for 5 hrs at 75° C. to prepare a particulate resin dispersion.

Nine hundred and ninety (990) parts of water, 83 parts of the [particulate dispersion liquid], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium.

Eight hundred and sixty seven parts of the oil phase mixed liquid were mixed with 1,200 parts of the aqueous medium by T. K. Homomixer 13,000 rpm for 20 min to prepare an emulsified slurry.

The emulsified slurry was placed in a vessel including a stirrer and a thermometer, and after a solvent was removed therefrom at 30° C. for 8 hrs, the slurry was aged at 45° C. for 4 hrs to prepare a dispersion slurry.

After 100 parts of the dispersion slurry was filtered under reduced pressure, 100 parts of ion-exchange water were added to the filtered cake and mixed by T. K. Homomixer at 12,000 rpm for 10 min, and the mixture was filtered.

A hydrochloric acid including hydrochloride in an amount of 10% by weight were added to the filtered cake to have a pH of 2.8 and mixed by T. K. Homomixer at 12,000 rpm for 10 min, and the mixture was filtered.

Further, 300 parts of ion-exchange water were added to the filtered cake and mixed by T. K. Homomixer at 12,000 rpm for 10 min, and the mixture was filtered. This operation was repeated again to prepare a final filtered cake.

The final filtered cake was dried by an air drier at 45° C. for 48 hrs, and sieved with a mesh having an opening of 75 μm to prepare mother toner particles.

### (Application of External Additive)

One point five (1.5) parts of hydrophobic silica the surface of which is treated with hexamethyldisilazane, having a hydrophobization of 65% and an average primary particle diameter of 140 nm were added to 100 parts of the mother toner particles, and mixed by HENSCHEL MIXER from Mitsui Mining Co., Ltd. at 33 m/s for 3 min. The mixed powder was passed through a mesh having an opening of 38 μm to remove coarse powders. Thus, a toner a hydrophobized silica is externally added to was prepared.

### <<Evaluation>>

### (Photoreceptor Abrasion Amount, Toner Scrape Through Amount, Blade Edge Abrasion Amount and Contamination)

One hundred thousand (100,000) images of an A4 size chart having an image area of 5% were produced in black at 23° C. and 55% RH.

### (Photoreceptor Abrasion Amount)

After 100,000 images were produced, a photoreceptor was taken out to measure a surface layer thickness by an eddy current film thickness meter FISCHERSCOPE MMS from FISCHER INSTRUMENTS K.K.

The abrasion amount was a difference of the thickness before and after 100,000 images were produced.

### (Toner Scrape Through Amount)

After 100,000 images were produced, 100 images of the same chart having an image area of 5% were produced. After 100 images were produced, a solid image was produced to control the image density to be about 1.4 when measured by X-Rite 938 from X-Rite, Inc. Then, a toner catcher (formed of a polyethylene fiber Dyneema ND-200 from TOYOBO CO., LTD.) was installed to catch a toner having scraped through the cleaner.

Next, 10 solid image were produced and a toner caught by the toner catcher is determined as a toner having scraped through the cleaner to evaluate cleanability.

The toner having scraped through the cleaner was quantified by the following method. The toner catcher was scanned by a scanner ES-8500 from Seiko Epson Corporation at 24 bit color 600 dpi. The scanned image was digitalized using image analysis software LMeye from Lasertec Corp. and processed to calculate a luminance data and an area of a toner in the toner catcher. The less they are, the better the cleanability.

### (Blade Edge Abrasion Width)

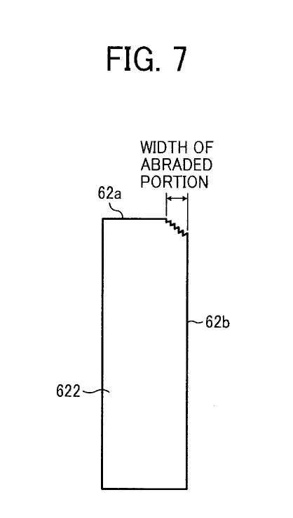

As FIG. 7 shows, an abrasion width from the blade edge was measured, using a confocal microscope OPTELICS H1200 from Lasertec Corp under the following conditions.

Measurement Mode: MAX Peak

Lens magnification: Objective 50-fold

Color: MIX

### (Photoreceptor Contamination)

The electrophotographic photoreceptor after 100,000 images were produced was observed by a confocal microscope OPTELICS H1200 from Lasertec Corp under the following conditions to evaluate contamination.

Measurement Mode: MAX Peak

Lens magnification: Objective 5-fold

Color: MIX

The contaminations were graded to the following 5 grades. No problem in practical use from 3 to 5.

5: No contamination

4: Almost no contamination

3: Slight contamination

2: Widely contaminated

1: Wholly contaminated

### (High Temperature [HT] & High Humidity [HH] Environment Contamination)

Ten thousand (10,000) images of an A4 size chart having an image area of 5% were produced in black at 30° C. and 90% RH to evaluate contamination of the photoreceptor, using a confocal microscope OPTELICS H1200 from Lasertec Corp under the following conditions.

Measurement Mode: MAX Peak

Lens magnification: Objective 5-fold

Color: MIX

The contaminations were graded to the following 5 grades. No problem in practical use from 3 to 5.

5: No contamination

4: Almost no contamination

3: Slight contamination

2: Widely contaminated

1: Wholly contaminated

### (Chipped Blade Edge Rank at Low Temperature [LT] & Low Humidity [LH])

Ten thousand (10,000) images of an A4 size chart having an image area of 5% were produced in black at 10° C. and 15% RH to evaluate chipped blade edge at low temperature and low humidity.

The edge was observed by a confocal microscope OPTELICS H1200 from Lasertec Corp under the following conditions.

Measurement Mode: MAX Peak

Lens magnification: Objective 50-fold

Color: MIX

The chipped statuses were graded to the following 4 grades. No problem in practical use from 2 to 4.

4: Never chipped

3: Slightly chipped

2: Not widely chipped

1: Widely chipped

The evaluation results are shown in Table 3.

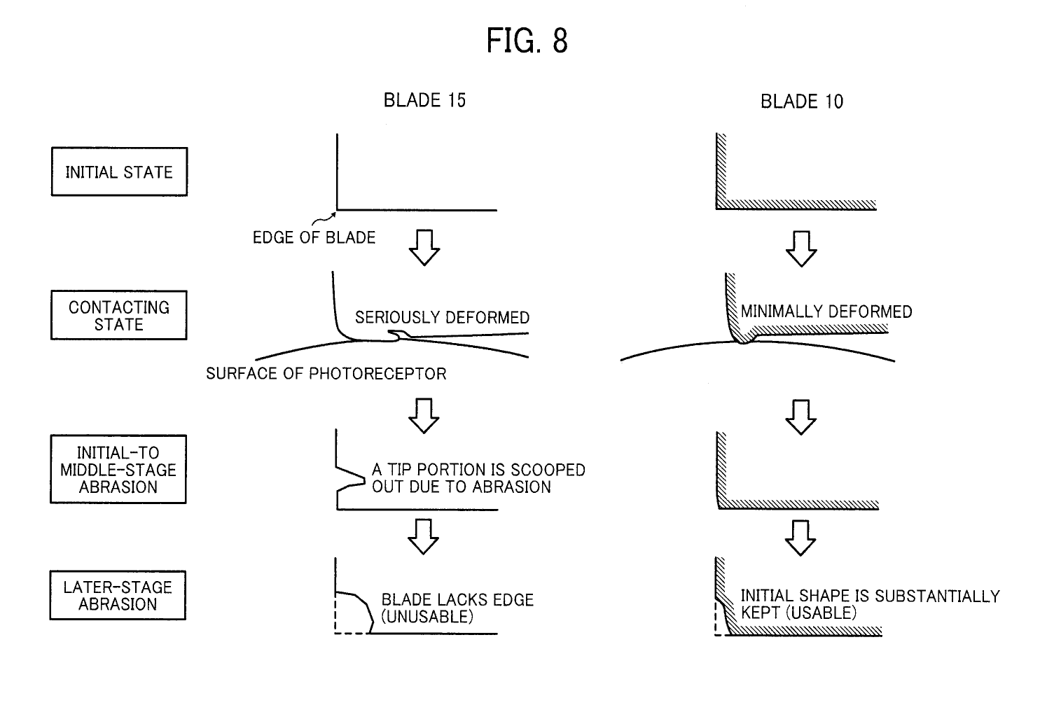

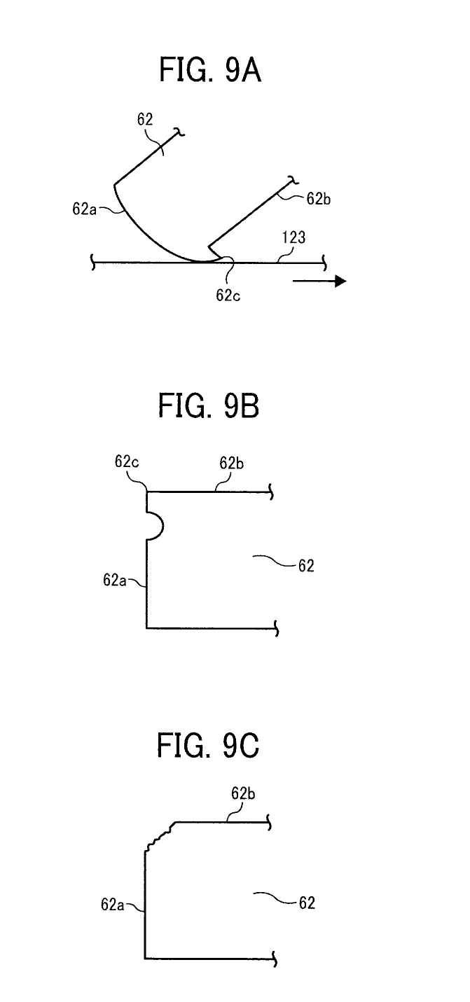

FIG. 8 shows abrasion progresses of the blade 10 and the blade 15 in Comparative Example 5.

The blade 10 having an elastic blade having a contact point contacting an electrophotographic photoreceptor, which is formed of a substrate, a 1.0 μm or more thick mixed layer formed of materials forming the substrate and an acrylic and/or a methacrylic resin and a 1.0 μm or more thick acrylic and/or a methacrylic resin surface layer is deformed less when contacting the electrophotographic photoreceptor and capable of maintaining the shape. The blade 15 not having such a layer composition was largely deformed when contacting the electrophotographic photoreceptor, everted and abraded as time passed, and the blade lacked as abraded.

TABLE 3

| | | | | | Blade edge | | | |
|---|---|---|---|---|---|---|---|---|
| | Photo- | | Abrasion | Toner scrape- | abrasion | | HT/HH | LT/LH |
| | receptor | Blade | amount (μm) | through amount | width (μm) | Contamination | Contamination | Chipped blade |
| Example 1 | 1 | 10 | 1.1 | 33 | 7 | 3 | 5 | 4 |
| Example 2 | 2 | 10 | 0.7 | 37 | 8 | 3 | 5 | 4 |
| Example 3 | 3 | 10 | 0.8 | 12 | 5 | 3 | 5 | 4 |
| Example 4 | 4 | 10 | 0.5 | 16 | 6 | 4 | 5 | 4 |
| Example 5 | 5 | 10 | 0.5 | 19 | 3 | 4 | 5 | 4 |
| Example 6 | 6 | 10 | 0.4 | 18 | 4 | 4 | 5 | 4 |
| Example 7 | 7 | 10 | 0.5 | 10 | 5 | 5 | 5 | 4 |
| Example 8 | 8 | 10 | 0.4 | 9 | 6 | 5 | 5 | 4 |
| Example 9 | 9 | 10 | 0.5 | 12 | 8 | 5 | 5 | 4 |
| Example 10 | 10 | 10 | 0.4 | 15 | 7 | 5 | 5 | 4 |
| Example 11 | 11 | 10 | 0.3 | 16 | 3 | 5 | 5 | 4 |
| Example 12 | 12 | 10 | 0.3 | 18 | 6 | 5 | 5 | 4 |
| Example 13 | 13 | 10 | 0.2 | 20 | 5 | 5 | 5 | 4 |
| Example 14 | 14 | 10 | 0.3 | 16 | 8 | 5 | 5 | 4 |
| Example 15 | 15 | 10 | 0.1 | 14 | 9 | 5 | 5 | 4 |
| Example 16 | 16 | 10 | 0.2 | 13 | 8 | 5 | 5 | 4 |
| Example 17 | 17 | 10 | 0.5 | 16 | 4 | 5 | 5 | 4 |
| Example 18 | 18 | 10 | 0.2 | 20 | 5 | 5 | 5 | 4 |
| Example 19 | 19 | 10 | 0.2 | 18 | 6 | 5 | 5 | 4 |
| Example 20 | 20 | 10 | 0.2 | 17 | 6 | 5 | 5 | 4 |
| Example 21 | 21 | 10 | 0.3 | 20 | 8 | 5 | 5 | 4 |
| Example 22 | 16 | 1 | 0.3 | 11 | 16 | 3 | 3 | 3 |
| Example 23 | 16 | 2 | 0.2 | 15 | 5 | 3 | 3 | 4 |
| Example 24 | 16 | 3 | 0.4 | 16 | 9 | 5 | 3 | 3 |
| Example 25 | 16 | 4 | 0.2 | 9 | 8 | 4 | 4 | 3 |
| Example 26 | 16 | 5 | 0.3 | 15 | 4 | 5 | 5 | 4 |
| Example 27 | 16 | 6 | 0.3 | 10 | 7 | 5 | 5 | 3 |
| Example 28 | 16 | 7 | 0.5 | 16 | 5 | 5 | 5 | 3 |
| Example 29 | 16 | 8 | 0.5 | 17 | 3 | 5 | 5 | 4 |
| Example 30 | 16 | 9 | 0.2 | 18 | 6 | 5 | 5 | 4 |
| Example 31 | 16 | 10 | 0.1 | 16 | 8 | 5 | 5 | 4 |
| Example 32 | 16 | 11 | 0.3 | 12 | 5 | 5 | 5 | 4 |
| Example 33 | 16 | 12 | 0.4 | 13 | 7 | 5 | 5 | 4 |
| Example 34 | 16 | 13 | 0.3 | 14 | 5 | 5 | 5 | 4 |
| Example 35 | 16 | 14 | 0.2 | 15 | 6 | 5 | 5 | 4 |
| Comparative | 22 | 10 | 0.7 | 55 | 32 | 2 | 2 | 4 |
| Example 1 | | | | | | | | |
| Comparative | 23 | 10 | 0.2 | 97 | 16 | 3 | 3 | 3 |
| Example 2 | | | | | | | | |
| Comparative | 24 | 10 | 0.3 | 65 | 33 | 2 | 2 | 4 |
| Example 3 | | | | | | | | |
| Comparative | 25 | 10 | 0.7 | 90 | 16 | 3 | 3 | 3 |
| Example 4 | | | | | | | | |
| Comparative | 16 | 15 | 0.4 | 25 | 45 | 3 | 2 | 1 |
| Example 5 | | | | | | | | |
| Comparative | 16 | 16 | 0.3 | 65 | 35 | 1 | 2 | 3 |
| Example 6 | | | | | | | | |
| Comparative | 16 | 17 | 0.3 | 23 | 26 | 3 | 2 | 1 |
| Example 7 | | | | | | | | |
| Comparative | 16 | 18 | 0.2 | 45 | 19 | 3 | 2 | 3 |
| Example 8 | | | | | | | | |
| Comparative | 16 | 19 | 0.4 | 40 | 26 | 3 | 2 | 2 |
| Example 9 | | | | | | | | |

Having now fully described the invention, it will be apparent to one of ordinary skill in the art that many changes and modifications can be made thereto without departing from the spirit and scope of the invention as set forth therein.

What is claimed is:

1. An image forming apparatus, comprising:
an electrophotographic photoreceptor; and
a cleaning blade,
wherein the electrophotographic photoreceptor comprises an outermost layer having a ten-point average roughness Rz of from 0.5 to 2.4 μm and an average interval between concavities and convexities Sm of from 30 to 300 μm, and the cleaning blade comprises a reed-shaped elastic blade having a contact point to the electrophotographic photoreceptor,
wherein the contact point comprises:
a substrate;
a mixed layer overlying the substrate, comprising a material forming the substrate and at least one of an acrylic resin and a methacrylic resin and having a thickness not less than 1.0 μm; and
a surface layer overlying the mixed layer, comprising at least one of an acrylic resin and a methacrylic resin and having a thickness not less than 0.1 μm.

2. The image forming apparatus of claim 1, wherein the electrophotographic photoreceptor further comprises a photosensitive layer, and wherein the outermost layer is a protection layer overlying the photosensitive layer.

3. The image forming apparatus of claim 2, wherein the protection layer comprises a filler.

4. The image forming apparatus of claim 3, wherein the filler is a metal oxide.

5. The image forming apparatus of claim 3, wherein the protection layer comprises the filler in an amount of from 10 to 40% by volume.

6. The image forming apparatus of claim 3, wherein the filler has an average particle diameter of from 10 to 100 nm.

7. The image forming apparatus of claim 1, wherein the surface layer has a thickness of from 0.5 to 1.0 μm.

8. The image forming apparatus of claim 1, wherein the mixed layer has a thickness of from 10 to 30 μm.

9. A process cartridge detachable from the image forming apparatus according to claim 1, comprising a cleaning blade, an electrophotographic photoreceptor, and one of a charger, an irradiator, an image developer, a transferer and a discharger.
